(19) United States
(12) Patent Application Publication
(10) Pub. No.: US 2015/0095822 A1
(43) Pub. Date: Apr. 2, 2015

(54) SYSTEMS AND METHODS FOR MUSIC DISPLAY, COLLABORATION, ANNOTATION, COMPOSITION, AND EDITING

(71) Applicant: eScoreMusic, Inc., Philadelphia, PA (US)

(72) Inventors: Steven Feis, Philadelphia, PA (US); Jeremy Sawruk, Allentown, PA (US); Ashley Gavin, New York, NY (US)

(21) Appl. No.: 14/568,027

(22) Filed: Dec. 11, 2014

Related U.S. Application Data
(63) Continuation-in-part of application No. 13/933,044, filed on Jul. 1, 2013.
(60) Provisional application No. 61/667,275, filed on Jul. 2, 2012.
(60) Provisional application No. 61/917,897, filed on Dec. 18, 2013.

(51) Int. Cl. G06F 3/0483; G06F 3/0484

(52) U.S. Cl. CPC G06F 3/0483; G06F 3/04842
USPC 715/765

(57) ABSTRACT

Music Display, Collaboration, Annotation, Composition, and Editing (MDCACE) systems and methods are provided. Elements in music scores are presented as “layers” on user devices which may be manipulated by users as desired. For example, users may elect to hide or show a particular layer, designate a display color for the layer, or configure the access to the layer by users or user groups. Users may also create annotation layers, each with individual annotations such as music symbols or notations, comments, free-drawn graphics, staging directions, or the like Annotations such as staging directions and orchestral cues may also be generated automatically by the system. Real-time collaborations among multiple MDCACE users are promoted by the sharing and synchronization scores, annotations or changes. In addition, master MDCACE users such as conductors may coordinate or control aspects of the presentation of music scores on other user devices.

### CROSS-REFERENCE

This application is a continuation-in-part application of Ser. No. 13/933,044, filed Jul. 1, 2013, to which application we claim priority under 35 USC §120, and which claims the priority of U.S. Provisional Application Ser. No. 61/667,275, filed Jul. 2, 2012; and this application also claims the priority of U.S. Provisional Application Ser. No. 61/917,897, filed Dec. 18, 2013, which are incorporated herein by reference in their entirety.

### BACKGROUND OF THE INVENTION

Composition, editing, rehearsal, and performance of musical scores sometimes involve collaboration among multiple musicians.

When rehearsing and performing, musicians typically read from and make notes in printed sheet music which is placed on a music stand. More recently, musicians have used electronic device to display their music. However, the display capability and flexibility of these devices can be limited.

Operational transformation is a system of technologies that enable real-time document collaboration among multiple clients by providing a means of automatic conflict resolution that ensures document consistency across all clients. Under this paradigm, users read a version of a document from a server; a user's edit to this document generates a transformation, particular an Insert operation or a Delete operation; this transformation is applied on the server and to the documents of other users, and only transforms are sent, reducing the network bandwidth; and consistency model ensures that all documents are synchronized. In a text document, edit points are uniquely identified (addressable) by the offset within the document. For instance, consider the text string “abc” replicated at two collaborating sites, with two concurrent operations to that string generated by two users at collaborating sites 1 and 2, respectively: the first operation (“O1”) is to insert character “x” at position “0”; the second operation (“O2”) is to delete the character “c” at position 2. Suppose the two operations are executed in the order of O1 and O2 (at site 1). After executing O1, the document becomes “xabc”. To execute O2 after O1, O2 must be transformed against O1 to indication a deletion of “c” at position 3 rather than at position 2; the positional parameter is incremented by one due to the insertion of one character, “x”, by O1. Executing this modified operation on “xabc” deletes the correct character “c”, and the document becomes “xab”. However, were O2 executed without transformation, it would incorrectly delete character “b” rather than “c”.

### SUMMARY OF THE INVENTION

Systems and methods for music display, collaboration, annotation, composition, and editing are provided herein.

According to an aspect of the invention, a computer-implemented method is provided for providing and/or modifying musical score information associated with a music score. The method includes storing a plurality of layers of the musical score information, where at least some of the plurality of layers of musical score information received are from one or more users. The method also includes providing, in response to request by a user to display the musical score information, a subset of the plurality of layers of the musical score information based at least in part on an identity of the user.

According to another aspect of the invention, one or more non-transitory computer-readable storage media are provided, having stored thereon executable instructions that, when executed by one or more processors of a computer system, cause the computer system to at least provide a user interface configured to display musical score information associated with a music score as a plurality of layers, display, via the user interface, a subset of the plurality of layers of musical score information based at least in part on a user preference, receive, via the user interface, a modification to at least one of the subset of the plurality of layers of musical score information, and display, via the user interface, the modification to at least one of the subset of the plurality of layers of musical score information.

According to another aspect of the invention, a computer system is provided for facilitating musical collaboration among a plurality of users each operating a computing device. The system comprises one or more processors, and memory, including instructions executable by the one or more processors to cause the computer system to at least receive, from a first user of the plurality of users, an layer of musical score information associated with a music score and one or more access control rules associated with the layer, and determine whether to make the annotation layer available to a second user of the plurality of users based at least in part on the one or more access control rules.

According to another aspect of the invention, a computer-implemented method is provided for displaying a music score on a user device associated with a user. The method comprises determining a display context associated with the music score; and rendering a number of music score elements on the user device, the number selected based at least in part on the display context.

According to another aspect of the invention, collaborative composition and editing of musical scores is accomplished by applying operational transformations to documents describing musical scores.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIGS. 1-8 illustrate examples of environment for implementing the present invention, in accordance with at least one embodiment.

FIG. 9 illustrates example components of a computer device for implementing aspects of the present invention, in accordance with at least one embodiment.

FIG. 10 illustrates an example representation of musical score information, in accordance with at least one embodiment.

FIG. 11 illustrates an example user interface (“UI”) for configuring user preferences, in accordance with at least one embodiment.

FIG. 12 illustrates an example representation of musical score information, in accordance with at least one embodiment.

FIG. 13 illustrates an example representation of musical score information, in accordance with at least one embodiment.

FIGS. 14-16 illustrates example user interfaces (UIs) provided by an MDCACE service, in accordance with at least one embodiment.

FIGS. 17-19 illustrates example UIs showing example annotation types and example annotations associated with the annotation types, in accordance with at least one embodiment.

FIG. 20 illustrates an example UI for selecting a music range for which an annotation applies, in accordance with at least one embodiment.

FIG. 21 illustrates an example UI showing annotations applied to a selected music range, in accordance with at least one embodiment.

FIG. 22 illustrates an example annotation panel for providing an annotation, in accordance with at least one embodiment.

FIG. 23 illustrates an example text input form for providing textual annotations, in accordance with at least one embodiment.

FIGS. 24-26 illustrate example UIs for providing staging directions, in accordance with some embodiments.

FIG. 27 illustrates example UIs for providing continuous display of musical scores, in accordance with at least one embodiment.

FIG. 28 illustrates an example UI for sharing musical score information, in accordance with at least one embodiment.

FIG. 29 illustrates an example process for implementing an MDCACE service, in accordance with at least one embodiment.

FIG. 30 illustrates an example process for implementing an MDCACE service, in accordance with at least one embodiment.

FIG. 31 illustrates an example process for creating an annotation layer, in accordance with at least one embodiment.

FIG. 32 illustrates an example process for providing annotations, in accordance with at least one embodiment.

FIG. 33 illustrates some example layouts of a music score, in accordance with at least one embodiment.

FIG. 34 illustrates an example layout of a music score, in accordance with at least one embodiment.

FIG. 35 illustrates an example embodiment of music score display, in accordance with at least one embodiment.

FIG. 36 illustrates an example process for displaying a music score, in accordance with at least one embodiment.

FIG. 37 illustrates an example process for providing orchestral cues in a music score, in accordance with at least one embodiment.

FIG. 38 illustrates an example process for using multiple channels to selectively convey operational transformations describing additions or modifications to a musical score.

FIGS. 39-40 illustrate an example process for implementing in a model-view-controller paradigm operational transformations describing additions or modifications to a musical score.

FIG. 41 illustrates an example UI for viewing information pertaining to historical modifications to a musical score, in accordance with at least one embodiment.

### DETAILED DESCRIPTION OF THE INVENTION

Music Display, Collaboration, Annotation, Composition, and Editing (MDCACE) systems and methods are provided. In some embodiments, elements in music scores are presented as “layers” on user devices which may be manipulated by users as desired. For example, users may elect to hide or show a particular layer, designate a display color for the layer, or configure the access to the layer by users or user groups. Users may also create annotation layers, each with individual annotations such as music symbols or notations, comments, free-drawn graphics, staging directions, or the like Annotations such as staging directions and orchestral cues may also be generated automatically by the system. Real-time collaborations among multiple MDCACE users are promoted by the sharing and synchronization of scores, annotations, additions, deletions, and additional modifications. In addition, master MDCACE users such as conductors may coordinate or control aspects of the presentation of music scores on other user devices. It shall be understood that different aspects of the invention can be appreciated individually, collectively, or in combination with each other.

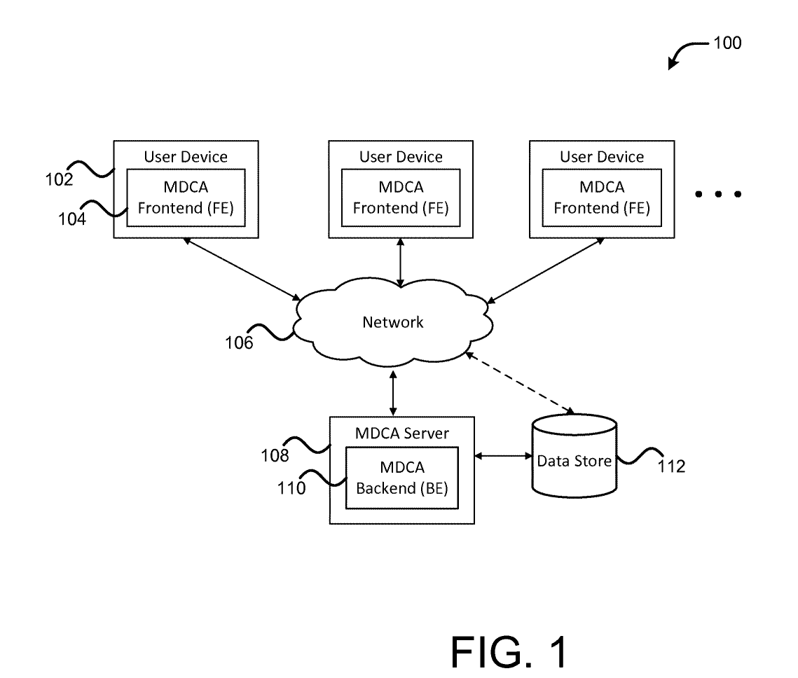

FIG. 1 illustrates an example environment 100 for implementing the present invention, in accordance with at least one embodiment. In an embodiment, one or more user devices 102 connect via a network 106 to a MDCACE server 108 to utilize the MDCACE service described herein. It shall be understood that all references to a “MDCA” server or service within the description and figures herein further include or may be interchangeable with a “MDCACE” server or service.

In various embodiments, the user devices 102 may be operated by users of the MDCACE service such as musicians, conductors, singers, composers, stage managers, page turners, and the like. In various embodiments, the user devices 102 may include any devices capable of communicating with the DMCA server 108, such as personal computers, workstations, laptops, smartphones, tablet computing devices, and the like. Such devices may be used by musicians or other users during composition, a rehearsal, or a performance, for example, to view, to create, or to modify music scores. In some embodiments, the user devices 102 may include or be part of a music display device such as a music stand. In some cases, the user devices 102 may be configured to rest upon or be attached to a music display device. The user devices 102 may include applications such as web browsers capable of communicating with the MDCACE server 108, for example, via an interface provided by the MDCACE server 108. Such an interface may include an application programming interface (API) such as a web service interface, a graphical user interface (GUI), and the like.

The MDCACE server 108 may be implemented by one or more physical and/or logical computing devices or computer systems that collectively provide the functionalities of a MDCACE service described herein. In an embodiment, the MDCACE server 108 communicates with a data store 112 to retrieve and/or store musical score information and other data used by the MDCACE service. The data store 112 may include one or more databases (e.g., SQL database), data storage devices (e.g., tape, hard disk, solid-state drive), data storage servers, and the like. In various embodiments, such a data store 112 may be connected to the MDCACE server 108 locally or remotely via a network.

In some embodiments, the MDCACE server 108 may comprise one or more computing services provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

In some embodiments, data store 112 may comprise one or more storage services provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

In various embodiments, network 106 may include the Internet, a local area network (“LAN”), a wide area network (“WAN”), a cellular data network, wireless network or any other public or private data network.

In some embodiments, the MDCACE service described herein may comprise a client-side component 104 (hereinafter frontend or FE) implemented by a user device 102 and a server-side component 110 (hereinafter backend or BE) implemented by a MDCACE server 108. The client-side component 104 may be configured to implement the frontend logic of the MDCACE service such as receiving, validating, or otherwise processing input from a user (e.g., annotations within a music score), sending the request (e.g., an Hypertext Transfer Protocol (HTTP) request) to the MDCACE server, receiving and/or processing a response (e.g., an HTTP response) from the server component, and presenting the response to the user (e.g., in a web browser). In some embodiments, the client component 104 may be implemented using Asynchronous JavaScript and XML (AJAX), JavaScript, Adobe Flash, Microsoft Silverlight or any other suitable client-side web development technologies.

In an embodiment, the server component 110 may be configured to implement the backend logic of the MDCACE service such as processing user requests, storing and/or retrieving and/or modifying and/or creating data (e.g., from data store 112) and providing responses to user request (e.g., in an HTTP response), and the like. In various embodiments, the server component 110 may be implemented by one or more physical or logical computer systems using ASP, .Net, Java, Python, or any suitable server-side web development technologies.

In some embodiments, the client component and server component may communicate using any suitable web service protocol such as Simple Object Access Protocol (SOAP). In general, the allocation of functionalities of the MDCACE service between FE and BE may vary among various embodiments. For example, in an embodiment, the majority of the functionalities may be implemented by the BE and the FE implement minimal functionalities. In another embodiment, the majority of the functionalities may be implemented by the FE.

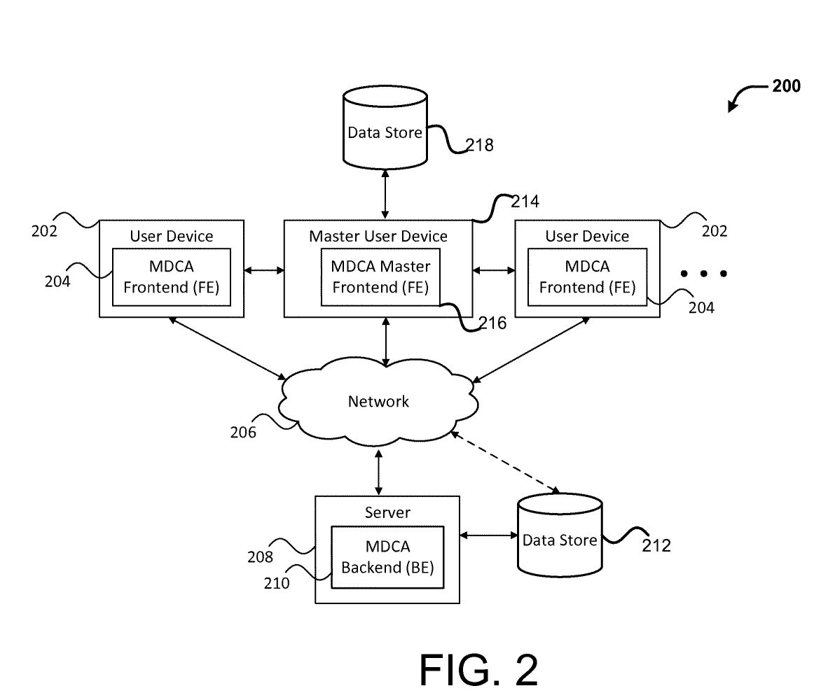

FIG. 2 illustrates another example environment 200 for implementing the present invention, in accordance with at least one embodiment. Similar to FIG. 2, user devices 202 implementing MDCACE FE 204 are configured to connect to MDCACE server 208 implementing MDCACE BE 210. However, in the illustrated embodiment, the user devices 202 may also be configured to connect to a master user device 214. In a typical embodiment, the user devices 202 connect to the master user device 214 via a local area network (LAN) or a wireless network. In other embodiments, the connection may be via any suitable network such as described above in connection with FIG. 1.

In some embodiments, the master device 214 may be a device similar to a user device 202, but the master device 214 may implement master frontend functionalities that may be different from the frontend logic implemented by a regular user device 202. For example, in some embodiments, the master user device 214 may be configured to act as a local server, e.g., to provide additional functionalities and/or improved performance and reliability.

In an embodiment, the master user device 214 may be configured to receive musical score information (e.g., score and annotations, modifications and/or additions and/or deletions to the musical score) and other related data (e.g., user information, access control information) from user devices 202 and/or to provide such data to the user devices 202. Such data may be stored in a client data store 218 that is connected to the master user device 214. As such, the client data store 218 may provide redundancy, reliability, and/or improved performance (e.g., increased speed of data retrieval, better availability) over the server data store 212. In some embodiments, the client data store 218 may be synchronized with server data store 212, for example, on a periodic basis or upon system startup. The client data store 218 may also store information (e.g., administrative information or user preferences) that is not stored in the server data store 212.

In a typical embodiment, the client data store 218 includes one or more data devices, data servers that are connected locally to the master user device 214. In other embodiments, the client data store 218 may include one or more remote data devices or servers, or data storage services (e.g., provisioned from a cloud storage service).

In some embodiments, the master user device 214 may be used to control aspects of presentation on other user devices 202. For example, the master device may be used to control which parts or layers are shown or available. As another example, the master device may provide display parameters to the user devices 202. As another example, the master user device 214, operated by a conductor or page turner, may be configured in order to provide a page turning service to user devices 202 by sending messages to the user devices 202 regarding the time or progression of the music. As another example, the master user device may be configured to send customized instructions (e.g., stage instructions) to individual user devices 202. In some embodiments, the master user device 214 may be configured to function just as a regular user device 202. As another example, the master FE may provide allow users with administrative power for managing musical score information from various users, controlling access to the musical score information, or performing other configurations and administrative functionalities.

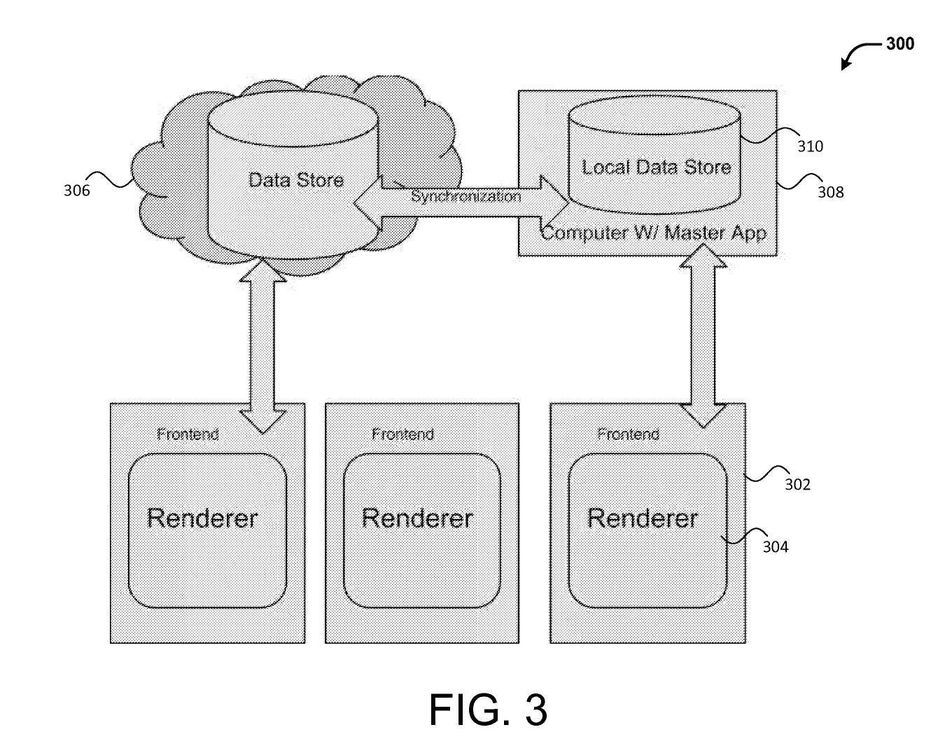

FIG. 3 illustrates another example environment 300 for implementing the present invention, in accordance with at least one embodiment. FIG. 3 is similar to FIG. 2, except some components of the user devices are shown in more detail while the MDCACE server is omitted.

According to the illustrated embodiment, MDCACE frontend may be implemented by a web browser or application 302 that resides on a user device such as the user devices 102 and 202 discussed in connection with FIGS. 1 and 2, respectively. The frontend 302 may include an embedded rendering engine 304 that may be configured to parse and properly display (e.g., in a web browser) data provided by a remote data store or data storage service 306 (e.g., a cloud-based data storage service). The rendering engine 304 may be further configured to provide other frontend functionalities such as allowing real-time annotations and/or creation and/or modification of musical scores.

The remote data store or data storage service 306 may be similar to the server data store 112 and 212 discussed in connection with FIGS. 1 and 2, respectively. In particular, the data store 306 may be configured to store musical scores, annotations, layers, user information, access control rules, and/or any other data used by the MDCACE service.

As illustrated, the frontend 302 embedding the rendering engine 304 may be configured to connect to a computing device 308 that is similar to the master user device 214 discussed in connection with FIG. 2. The computer device 308 may include a master application implementing master frontend logic similar to the MDCACE master frontend 216 implemented by the master user device 214 in FIG. 2. In particular, such a master application may provide services similar to those provided by the master user device 214, such as page turning service or other on-site or local services.

The computing device 308 with master application may be configured to connect to a local data store 310 that is similar to the client data store 218 discussed in connection with FIG. 2. The local data store 310 may be configured to be synchronized with the remote data store 306, for example, via push or pull technologies or a combination of both.

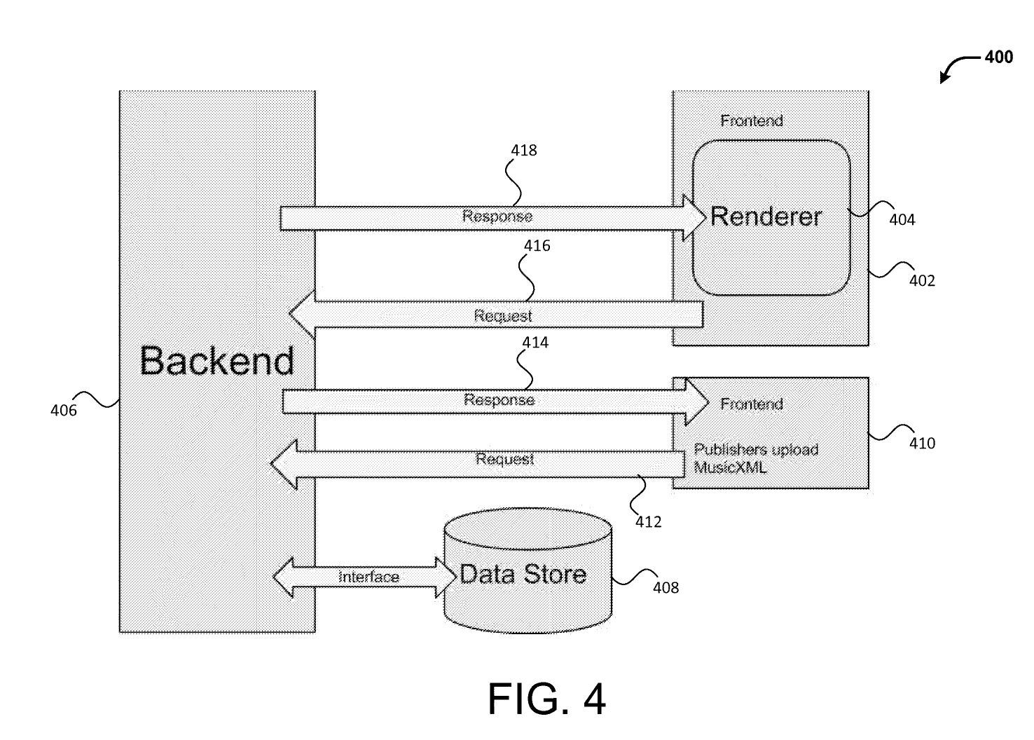

FIG. 4 illustrates another example environment 400 for implementing the present invention, in accordance with at least one embodiment. In this example, the backend 406 of a MDCACE service may obtain (e.g., import) one or more musical scores and related information from one or more musical score publishers or composers 410. For example, the music publisher 410 may upload, via a web browser, music scores in a suitable format such as MusicXML, JavaScript Object Notation (JSON), or the like via HTTP requests 412 and HTTP responses 412. The musical score from publishers or composers may be provided (e.g., using a pull or push technology or a combination of both) to the backend 406 on a periodic or non-periodic basis.

One or more user devices may each hosting an MDCACE frontend 402 that may include a web browser or application implementing a render 404. The frontend 402 may be configured to request from the backend 406 (e.g., via HTTP requests 416) musical scores such as uploaded by the music score publishers or composers and/or annotations uploaded by users or generated by the backend. The requested musical scores and/or annotations may be received (e.g., in HTTP responses 418) and displayed on the user devices. Further, the frontend 402 may be configured to enable users to provide annotations for musical scores, for example, via a user interface. Such musical score annotations may be associated with the music scores and uploaded to the backend 406 (e.g., via HTTP requests). The uploaded musical score annotations may be subsequently provided to other user devices, for example, when the underlying musical scores are requested by such user devices. In some embodiments, music scores and associated annotations may be exported by users and/or publishers.

In various embodiments, the music score publishers and/or composers and user devices may communicate with the backend 406 using any suitable communication protocols such via HTTP, File Transfer Protocol (FTP), SOAP, and the like.

The backend 406 may communicate with a data store 408 that is similar to the server data stores 112 and 212 discussed in connection with FIGS. 1 and 2, respectively. The data store 408 may be configured to store musical scores, annotations and related information.

In some embodiments, annotations and other changes or additions or deletions made to a music score may be stored in a proprietary format, leaving the original score intact on the data store 408. Such annotations and changes may be requested for rendering the music score on the client's browser. The backend 406 may determine whether an annotation or modification or addition or deletion has been made on a score or specific section of a score. After assessing whether any such change has been made, and what kind, the backend 408 may return a modified MusicXML segment or proprietary format to the frontend for rendering.

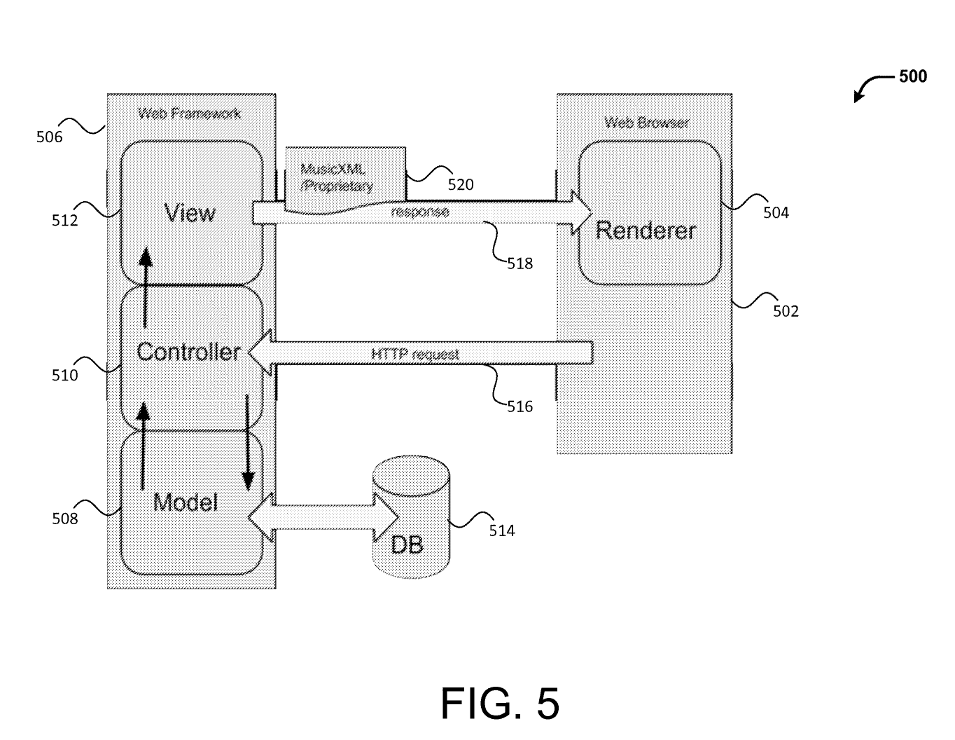

FIG. 5 illustrates another example environment 500 for implementing the present invention, in accordance with at least one embodiment. FIG. 5 is similar to FIG. 4, except components of the backend 506 are shown in more detail and musical score publishers are omitted.

In the illustrated embodiment, the backend 506 of the MDCACE service may implement a model-view-controller (MVC) web framework. Under this framework, functionalities of the backend 506 may be divided into a model component 508, a controller component 510 and a view component 512. The model component 508 may comprise application data, business rules and functions. The view component 512 may be configured to provide any output representation of data such as MusicXML. Multiple views on the same data are possible. The controller component 510 may be configured to mediate inbound requests to the backend 506 and convert them to commands for the model component 508 and/or the view component 512.

In an embodiment, a user device hosting an MDCACE frontend 502 with a renderer 504 may send a request (e.g., via HTTP request 516) to the backend 506. Such a request may include a request for musical score data (e.g., score and annotations) to be displayed on the user device, or a request to upload musical annotations associated with a music score. Such a request may be received by the controller component 510 of the backend 506. Depending on the specific request, the controller component 510 may dispatch one or more commands to the model component 508 and/or the view component 512. For example, if the request is to obtain the musical score data, the controller component 510 may dispatch the request to the model component 508, which may retrieves the data from data store 514 and provides the retrieved data to the controller component 510. The controller component 510 may pass the musical score data to the view component 512, which may format the data into a suitable format such as MusicXML, JSON, some other proprietary or non-proprietary format, and provide the formatted data 520 back to the requesting frontend 502 (e.g., in an HTTP response 518), for example, for rendering in a web browser.

The allocation of the functionalities of the MDCACE service may vary among different embodiments. For example, in an embodiment, the backend 506 provides a music score and associated annotation information to the frontend 502, which may determine whether to show or hide some of the annotation information based on user preferences. In another embodiment, the backend 506 determines whether to provide some of annotation information associated with a music score based on identity of the requesting user. Additionally, the backend 506 may modify the representation of the musical score data (e.g., MusicXML provided by the view component 512) based on front end commands and/or settings to alleviate the workload of the frontend. In yet another embodiment, a combination of both of the above approaches may be used. That is, both the backend and the frontend may perform some processing to determine the extent and format of the content to be provided and/or rendered.

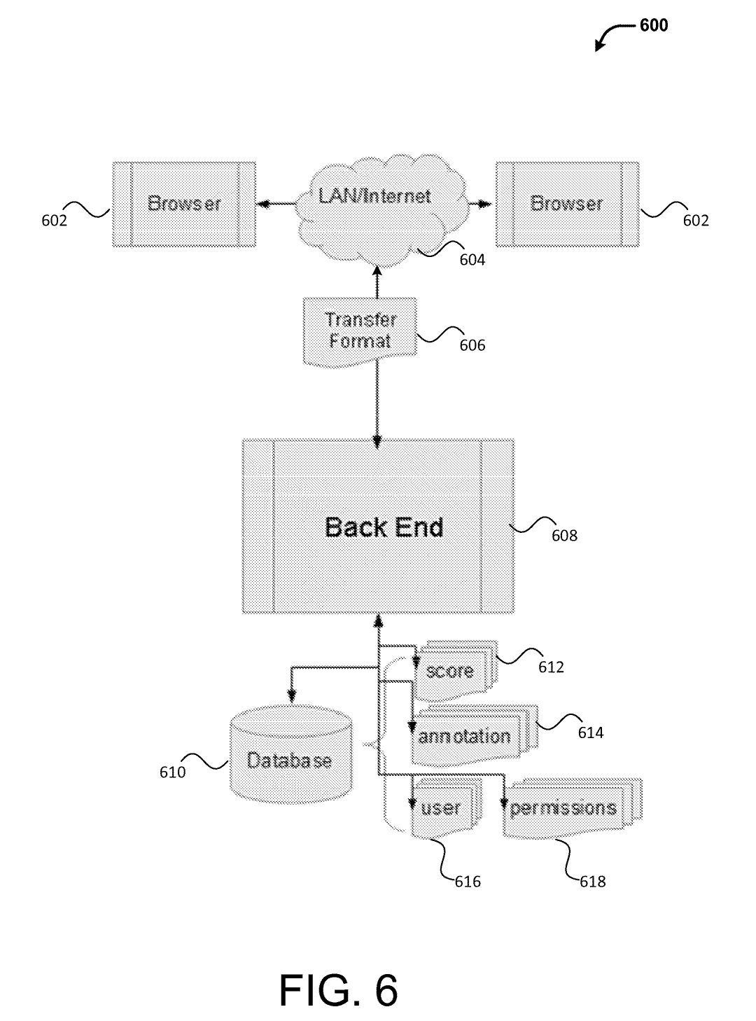

FIG. 6 illustrates another example environment 600 for implementing the present invention, in accordance with at least one embodiment. FIG. 6 is similar to FIGS. 4-5, except more details are provided with respect to the types of data stored into the server data store.

In the illustrated embodiment, user devices hosting frontends 602 connect, via a network 604, with backend 608 to utilize the MDCACE service discussed herein. The backend 608 connects with server data store 610 to store and/or retrieve data used by the MDCACE service. In various embodiments, such data may include musical scores 612, annotations 614, user information 616, permission or access control rules 618 and other related information. Permissions or access control rules may specify, for example, which users or groups of users have what kinds of access (e.g., read, write or neither) to a piece of data or information. In various embodiments, music score elements and annotations may be stored and/or as individual objects to provide more flexible display and editing options.

In various embodiments, user devices frontends 602 may include user devices such as user devices 102 and 202 discussed in connection with FIGS. 1 and 2, as well as master user devices such as master user device 214 discussed in connection with FIG. 2. The network 604 may be similar to the network 106 discussed in connection with FIG. 1. In various embodiments, the music score, annotation and other related data 606 exchanged between the frontends 602 and backend 608 may be formatted according to any suitable proprietary or non-proprietary data transfer or serialization format such as MusicXML, JSON, Extensible Markup Language (XML), YAML, or other proprietary or non-proprietary format.

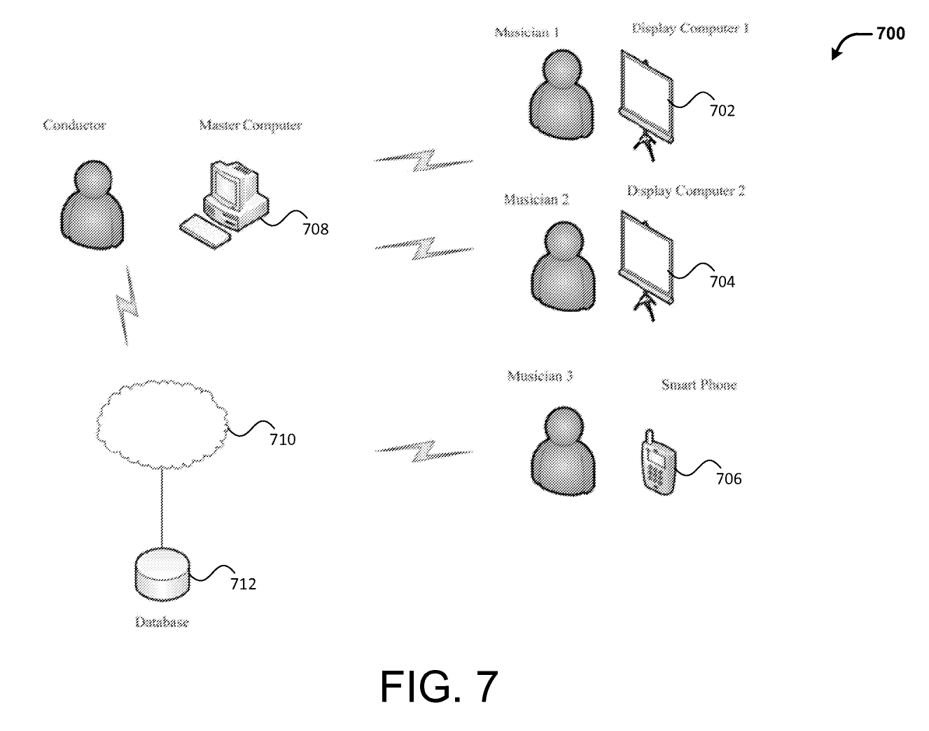

FIG. 7 illustrates another example environment 700 for implementing the present invention, in accordance with at least one embodiment. In particular, this example illustrates how the MDCACE service may be used by members of an orchestra. In various embodiments, the illustrated setting may apply to any musical ensemble such as a choir, string quartet, chamber orchestra, symphony orchestra, and the like, as well as multiple collaborating composers.

As illustrated, each musician operates a user device. The conductor (or a musical director, an administrator, a page turner, a composer, or any suitable user) operates a master computer 708 that may include a workstation, desktop, laptop, notepad or portable computer such as a tablet PC. Each of the musicians operates a portable user device 702, 704 or 706 that may include a laptop, notepad, tablet PC or smart phone. The devices may be connected via a wireless network or another type of data network.

The user devices 702, 704 and 706 may implement frontend logic of the MDCACE service, similar to user devices 302 discussed in connection with FIG. 3. For example, such user devices 702,704 and 706 may be configured to provide display of music scores and annotations, allow annotations of the music scores, and the like. Some of the user devices such as user device 706 may be connected, via network 710 and backend server (not shown), to the server data store 712. The musician operating such a user device 706 may request musical score information from and/or upload annotations to the data store 712.

Other user devices such as user devices 702 and 704 may be connected to the master computer 708 operated by the conductor, composer, or other similar user. The master computer 708 may be connected, via network 710 and backend server (not shown), to the server data store 712. In some embodiments, the master computer 708 may be similar to the master user device 214 and computer with master application 308 discussed in connection with FIGS. 2 and 3, respectively.

The master computer 708, operated by a conductor, musical director, page turner, administrator, composer, orchestrator, or any suitable user, may be configured to provide services to some or all of the users. Some services may be performed in real time, for example, during a performance or a rehearsal. For example, a conductor or page turner may use the master computer to provide indications of the timing and/or progression of the music to and/or to coordinate the display of musical scores on user devices 702 and 704 operated by performing musicians, whereas a composer might use the master computer to make changes to the musical score, whereby such changes are disseminated as they are made. Other services may involve displaying or editing of the musical score information. For example, a conductor may make annotations to a music score using the master computer and provide such annotations to user devices connected to the master computer. As another example, changes made at the master computer may be uploaded to the server data store 712 and/or be made available user devices not connected to the master computer. As another example, user devices may use the master computer as a local server to store data (e.g., when the remote server is temporarily down). Such data may be synched to the remote server (e.g., when the remote server is back online) using pull and/or push technologies.

In an embodiment, the master computer 708 is connected to a local data store (not shown) that is similar to the client data store 218 discussed in connection with FIG. 2. Such a local data store may be used as a “cache” or replica of the server data store 712 providing redundancy, reliability and/or improved performance. The local data store may be synchronized with the server data store 712 once in a while. In some embodiments, the client data store may also store information (e.g., administrative information or user preferences) that is not stored in the server data store 712.

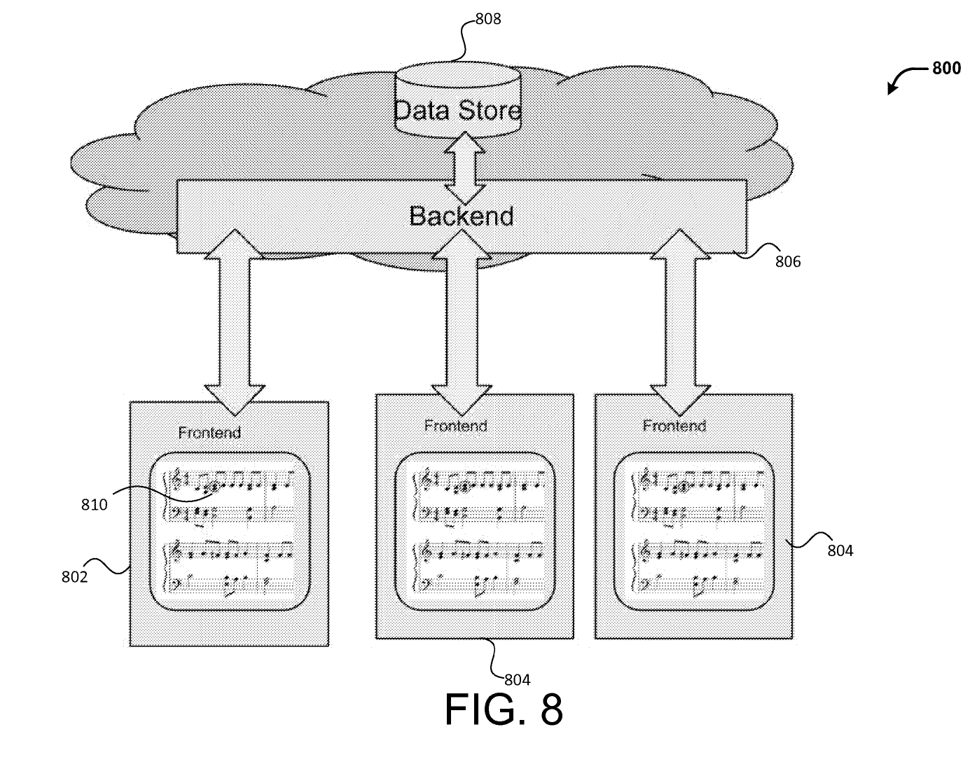

FIG. 8 illustrates another example environment for implementing the present invention, in accordance with at least one embodiment. Using the MDCACE service, multiple users can simultaneously view, annotate, create, and modify a music score using the MDCACE service. Changes or annotations made by the users may be synchronized in real-time, thereby providing live collaboration among users.

As illustrated, user devices hosting MDCACE frontends 802 and 804 (e.g., implemented by web browsers) connect, via a network (not shown), to backend 806 of an MDCACE service. The backend 806 is connected to a server data store 808 for storing and retrieving musical score related data. Components of the environment 800 may be similar to those illustrated in FIGS. 1 and 4.

In an embodiment, a user accessing the front end (e.g., web browser) 802 can provide annotations or changes 810 to a music score using frontend logic implemented by the frontend 802. Such annotations 810 may be uploaded to the backend 806 and server data store 808. In some embodiments, multiple users may provide annotations or changes to the same or different musical scores. The backend 806 may be configured to perform synchronization of the changes from different sources, resolving conflicts (if any) and store the changes to the server data store 808.

In some embodiments, changes made by one user may be made available to other, for example, using a push or pull technology or combination of both. In some cases, the changes may be provided in real time or after a period of time. For example, in an embodiment, the frontend implements a polling mechanism that pulls new changes or annotations to a user device 804. In some cases, changes that are posted to the server data store 808 may be requested within seconds or less of the posting. As another example, the server backend 806 may push new changes to the user. As another example, the server backend 806 may pull updates from user devices. Such pushing or pulling may occur on a periodic or non-periodic basis. In some embodiments, the frontend logic may be configured to synchronize a new edition of musical score or related data with a previous version.

The present invention can enable rapid comparison of one passage of music in multiple editions or pieces—as the user views one edition in the software, if that passage of music is different in other editions or pieces, a system can overlap the differences. This allows robust score preparation or analysis based on multiple editions or pieces without needing to review the entirety of all editions or pieces for potential variations or similarities—instead, the user need examine only those areas in which differences do indeed appear. Similarly, the score can compare multiple passages within (one edition of) one score.

Because annotations are stored in a database, such annotations can be shared not only among users in the same group (e.g. an orchestra), but also across groups. This enables, for instance, a large and well known orchestra to sell its annotations to those interested in seeing them. Once annotations are purchased or imported by a group or user, they are displayed as a layer in the same way as are other annotations from within the group. The shared musical scores and annotations also allow other forms of musical collaborations such as between friends, colleagues, acquaintances, and the like.

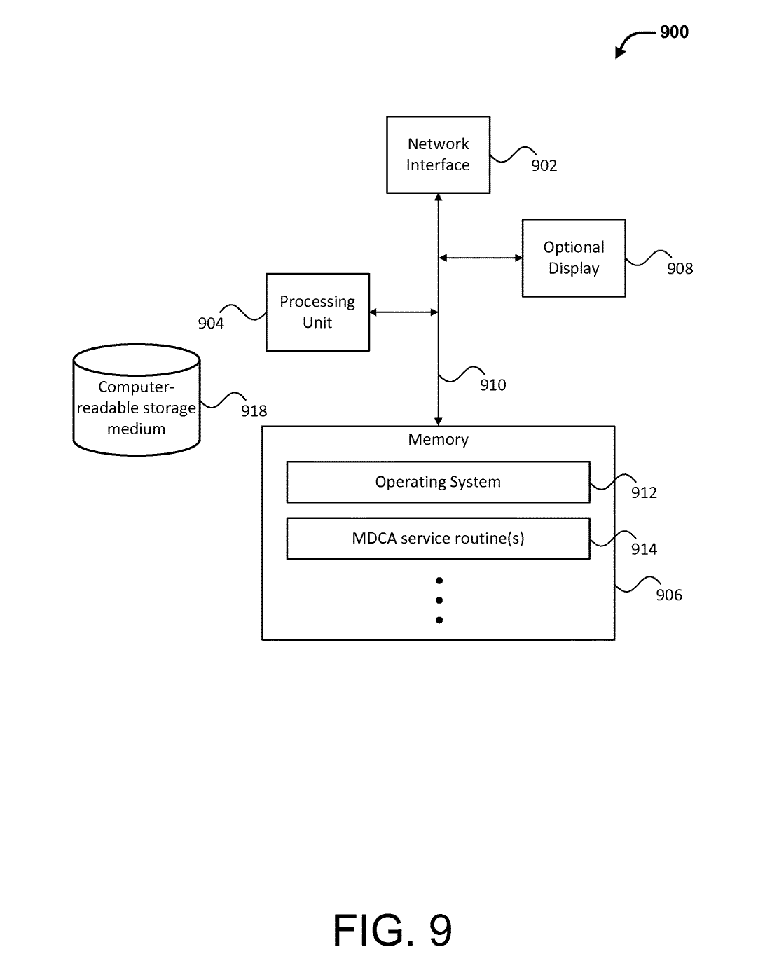

FIG. 9 illustrates example components of a computer device 900 for implementing aspects of the present invention, in accordance with at least one embodiment. In an embodiment, the computer device 900 may be configured to implement the MDCACE backend, frontend, or both. The computer device 900 may include or may be included in a device or system such as the MDCACE server 108 or a user device 102 discussed in connection with FIG. 1. In some embodiments, computing device 900 may include many more components than those shown in FIG. 9. However, it is not necessary that all of these generally conventional components be shown in order to disclose an illustrative embodiment.

As shown in FIG. 9, computing device 900 includes a network interface 902 for connecting to a network such as discussed above. In various embodiments, the computing device 900 may include one or more network interfaces 902 for communicating with one or more types of networks such as IEEE 802.11-based networks, cellular networks and the like.

In an embodiment, computing device 900 also includes one or more processing units 904, a memory 906, and an optional display 908, all interconnected along with the network interface 902 via a bus 910. The processing unit(s) 904 may be capable of executing one or more methods or routines stored in the memory 906. The display 908 may be configured to provide a graphical user interface to a user operating the computing device 900 for receiving user input, displaying output, and/or executing applications. In some cases, such as when the computing device 900 is a server, the display 908 may be optional.

The memory 906 may generally comprise a random access memory (“RAM”), a read only memory (“ROM”), and/or a permanent mass storage device, such as a disk drive. The memory 906 may store program code for an operating system 912, one or more MDCACE service routines 914, and other routines. The one or more MDCACE service routines 914, when executed, may provide various functionalities associated with the MDCACE service as described herein.

In some embodiments, the software components discussed above may be loaded into memory 906 using a drive mechanism associated with a non-transient computer readable storage medium 918, such as a floppy disc, tape, DVD/CD-ROM drive, memory card, USB flash drive, solid state drive (SSD) or the like. In other embodiments, the software components may alternatively be loaded via the network interface 902, rather than via a non-transient computer readable storage medium 918.

In some embodiments, the computing device 900 also communicates via bus 910 with one or more local or remote databases or data stores such as an online data storage system via the bus 910 or the network interface 902. The bus 910 may comprise a storage area network (“SAN”), a high-speed serial bus, and/or via other suitable communication technology. In some embodiments, such databases or data stores may be integrated as part of the computing device 900.

In various embodiments, the MDCACE service described herein allows users to provide annotations and modifications and additions to written representations of music, such as musical scores, and to control the display of written representations of music, such as musical score information. Written representations of music may include any type of representation of music, which may include musical score information, musical chords, or lyrics. Any description anywhere herein of musical score information may apply to any written representation of music and vice versa. Any or all of the written representation of music may be provided as layers. In some instances, some of the written representation of music need not be provided as layers. For example, musical score information may be provided as layers while chords and lyrics are not. Any or all of the written representation of the music may be edited, whether the written representation is in layers for not. For example, individual musical elements, such as notes may be edited from the musical score information, and individual chords and/or portions of lyrics may be edited.

As used herein, the term “musical score information” includes both a musical score and annotations associated with the musical score. Musical scores may include musical notes. Musical scores may or may not include any of the other musical elements described elsewhere herein. Musical score information may be logically viewed as a combination of one or more layers. As used herein, a “layer” is a grouping of score elements or annotations of the same type or of different types. Examples score elements may include musical or orchestral parts, vocal lines, piano reductions, tempi, blocking or staging directions, dramatic commentary, lighting and sound cues, notes for/by a stage manager (e.g., concerning entrances of singers, props, other administrative matters, etc.), comments for/by musical or stage director that are addressed to specific audience (e.g., singers, conductor, stage director, etc.), and the like. In some cases, a layer (such as that for a musical part) may extend along the entire length of a music score. In other cases, a layer may extend to only a portion or portions of a music score. In some cases, a plurality of layers (such as those for multiple musical parts) may extend co-extensively along the entire length of a music score or one or more portions of the music score.

In some embodiments, score elements may include annotations or additions or modifications provided by users or generated by the system. In various embodiments, annotations or additions or modifications may include musical notations that are chosen from a predefined set, text, freely drawn graphics, and the like. Musical notations may pertain to interpretative or expressive choices (dynamic markings such as p or piano or ffff or n or a hairpin decrescendo or cres. or articulation symbols such as those staccato and tenuto and accento and time-related symbols such as for fermata and ritardando or nit. or accel.), technical concerns (such as fingerings for piano, e.g. 1 for thumb, 3-2 meaning middle finger change to index finger; bowings, including standard symbols for up-bow and down-bow and arco and pizz., etc.), voice crossings, general symbols of utility (such as arrows facing upwards, downwards, to the right, to the left, and at 45 degree, 135 degree, 225 degree, and 315 degree angles from up=0), fermatas, musical lines such as to indicate ottava and for piano pedaling, and the like. Textual annotations or additions or modifications may include input staging directions, comments, notes, translations, cues, and the like. In some embodiments, the annotations or additions or modifications may be provided by users using an on-screen or physical keyboard or some other input mechanism such as via a mouse, finger, gesture, or the like.

In various embodiments, musical score information (including the music score and annotations thereof) may be stored as a collection of individual score elements such as measures, notes, symbols, and the like. As such, the music score information can be rendered (e.g., upon request) and/or edited at any suitable level of granularity such as measure by measure, note by note, part by part, layer by layer and or the like, thereby providing great flexibility.

In some cases, a single layer may provide score elements of the same type. For example, each orchestral part within a music score resides in a separate layer. Likewise, a piano reduction for multi-part scores, tempi, blocking/staging directions, dramatic commentary, lighting and sound cues, aria or recitative headings or titles, and the like may each reside in a separate layer.

As another example, notes for/by a stage manager, such as concerning entrances of singers, props, other administrative matters, and the like, can be grouped in a single layer. Likewise, comments addressed to a particular user or group of users may be placed in a single layer. Such a layer may provide easy access to the comments by such a user or group of users.

As another example, a vocal line in a music score may reside in a separate layer. Such a vocal line layer may include the original language text with notes/rhythms, phrase translations as well as enhanced material such as word-for-word translations, and International Phonetic Alphabet (IPA) symbol pronunciation. Such enhanced material may facilitate memorization of the vocal lines (e.g., by singers). In an embodiment, such enhanced material can be imported from a database to save efforts traditionally spent in score preparation. In an embodiment, the enhanced material is incorporated into existing vocal line material (e.g., original language text with notes/rhythms, phrase translations). In another embodiment, the enhanced material resides in a layer separate from the existing vocal line material.

In some embodiments, measure numbers for the music score may reside in a separate layer. The measure numbers may be associated with given pieces of music (e.g., in a given aria) or an entire piece. The measure numbers may reflect cuts or additions of music (i.e., they are renumbered automatically when cuts or additions are made to the music score).

In some other cases, a layer may include score elements of different types. For example, a user-created layer may include different types of annotations such as musical symbols, text, and/or free-drawn graphics.

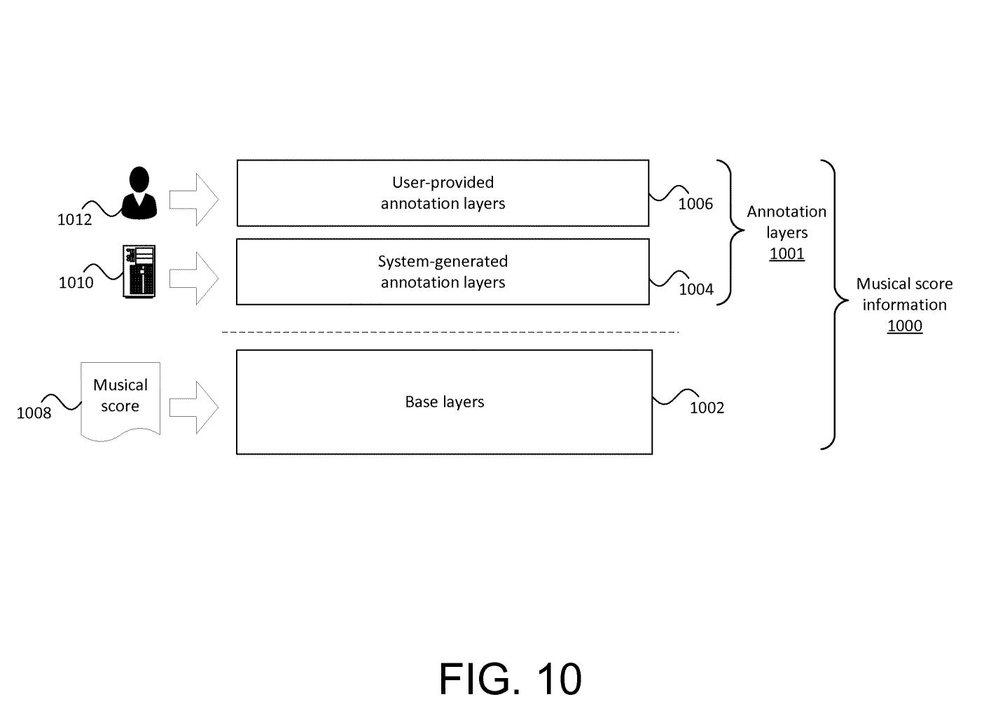

FIG. 10 illustrates a logical representation of musical score information 1000, in accordance with at least one embodiment.

In an embodiment, musical score information 1000 includes one or more base layers 1002 and one or more annotation layers 1001. The base layers 1002 include information that is contained in the original musical score 1008 such as musical parts, original vocal lines, tempi, dramatic commentary, and the like. In an embodiment, base layers may be derived from digital representations of music scores. The annotation layers 1001 may include system-generated annotation layers 1004 and/or user-provided annotations 1006. The system-generated annotation layers 1004 may include information that is generated automatically by one or more computing devices. Such information may include, for example, enhanced vocal line material imported from a database, orchestral cues for conductors, and the like. The user-provided annotation layers 1006 may include information input by one or more users such as musical symbols, text, free-drawn graphical objects, and the like.

In some embodiments, any given layer or set of score elements may be displayed or hidden on a given user device based on user preferences. In other words, at any given time, a user may elect to display a subset of the layers associated with a music score, while hiding the remaining (if any) layers. For example, a violinist may elect to show only the violin part of a multi-part musical score as well as annotations associated with the violin part, while hiding the other parts and annotations. On the other hand, the violinist may subsequently elect to show the flute part as well, for the purpose of referencing salient musical information in that part. In general, a user may filter the layers by the type of the score elements stored in the layers (e.g., parts vs. vocal lines, or textual vs. symbolic annotations), the scope of the layers (e.g., as expressed in a temporal music range), or the user or user group associated with the layers (e.g., creator of a layer or users with access rights to the layer).

In some embodiments, any given layer may be readable or editable by a given user based on access control rules or permission settings associated with the layer. Such rules or settings may specify, for example, which users or groups of users have what kinds of access rights (e.g., read, write or neither) to information contained in a given layer. In a typical embodiment, information included in base layers 1002 or a system-generated annotation layer 1004 is read-only, whereas information included in user-provided annotation layers 1006 may be editable. However, this may not be the case in some other embodiments. For example, in an embodiment, the MDCACE service may allow users to modify system-generated annotation and/or the original musical score, for instance for compositional purposes, adaptation, or the like.

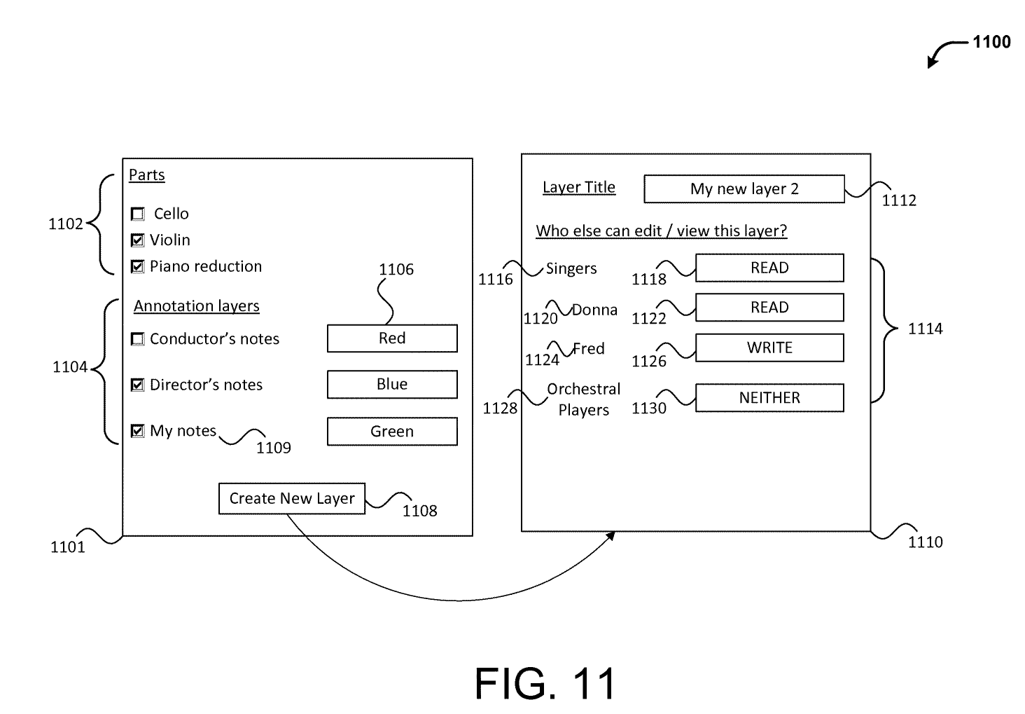

In an embodiment, a user may configure, via a user interface (“UI”), user preferences associated with the display of a music score and annotations and modifications associated with the music score. Such user preferences may include a user's desire to show or hide any layer (e.g., parts, annotations), display colors associated with layers or portions of the layers, access rights for users or user groups with respect to a layer, and the like. FIG. 11 illustrates an example UI 1100 for configuring user preferences, in accordance with at least one embodiment. In some embodiments, the UI 1100 may be implemented by a MDCACE frontend, backend or both.

As illustrated, the UI 1100 provides a layer selection screen 1101 for a user to show or hide layers associated with a music score. The layer selection screen 1101 includes a parts section 1102 showing some or all base layers associated with the music score. A user may show or hide each layer, for example, by selecting or deselecting a checkbox or a similar control associated with the layer. For example, as illustrated, the user has elected to show the parts for violin and piano reduction and to hide the part for cello.

The layer selection screen 1101 also includes an annotation layers section 1104 showing some or all annotation layers, if any, associated with the music score. A user may show or hide each layer, for example, by selecting or deselecting a checkbox or a similar control associated with the layer. For example, as illustrated, the user has elected to show the annotation layers with the director's notes and the user's own notes while hiding the annotation layer for the conductor's notes.

In an embodiment, display colors may be associated with the layers and/or components thereof so that the layers may be better identified or distinguished. Such display colors may be configurable by a user or provided by default. For example, in the illustrated example, a layer (base and/or annotation) may be associated with a color control 1106 for selecting a display color for the layer. In some embodiments, coloring can also be accomplished by assigning colors on a data-type by data-type basis, e.g., green for tempi, red for cues, and blue for dynamics. In some embodiments, users may demarcate musical sections by clicking on a bar line and changing its color as a type of annotation.

In an embodiment, users are allowed to configure access control of a layer via the user interface, for example, via an access control screen 1110. Such an access control screen 1110 may be presented to the user when the user creates a new layer (e.g., by selecting the “Create New Layer” button or a similar control 1108) or when the user selects an existing layer (e.g., by selecting a layer name such as “My notes” or a similar control 1109).

As illustrated, the access control screen 1110 includes a layer title field 1112 for a user to input or modify a layer title. In addition, the access control screen 1110 includes an access rights section 1114 for configuring access rights associated with the given layer. The access rights section 1114 includes one or more user groups 1116 and 1128. Each user group comprises one or more users 1120 and 1124. In some embodiments, a user group may be expanded (such as the case for “Singers” 1116) to show the users within the user group or collapsed (such as the case for “Orchestral Players” 1128) to hide the users within the user group.

A user may set an access right for a user group as a whole by selecting a group access control 1118 and 1130. For example, the “Singers” user group has read-only access to the layer whereas the “Orchestral Players” user group does not have the right to read or modify the layer. Setting the access right for a user group automatically sets the read/write permissions for every user within that group. However, a user may modify an access right associated with an individual user within a user group, for example, by selecting a user access control 1122 or 1126. For example, Fred's access right is set to “WRITE” even though his group's access right is set to “READ.” In some embodiments, a user's access right may be set to be the same as (e.g., for Donna) or a higher level of access (e.g., for Fred) than the group access right. In other embodiments, a user's access right may be set to a lower level than the group access right. In some other embodiments, users may be allowed to set permissions at user level or group level only.

In an embodiment, an annotation is associated with or applicable to a particular temporal music range within one or more musical parts. Thus, a given annotation may apply to a temporal music range that encompasses multiple parts (e.g., multiple staves and/or multiple instruments). Likewise, multiple annotations from different annotation layers may apply to the same temporal music range. Therefore, an annotation layer containing annotations may be associated with one or more base layers such as parts that the annotations apply to. Similarly, a base layer may be associated with one or more annotation layers.

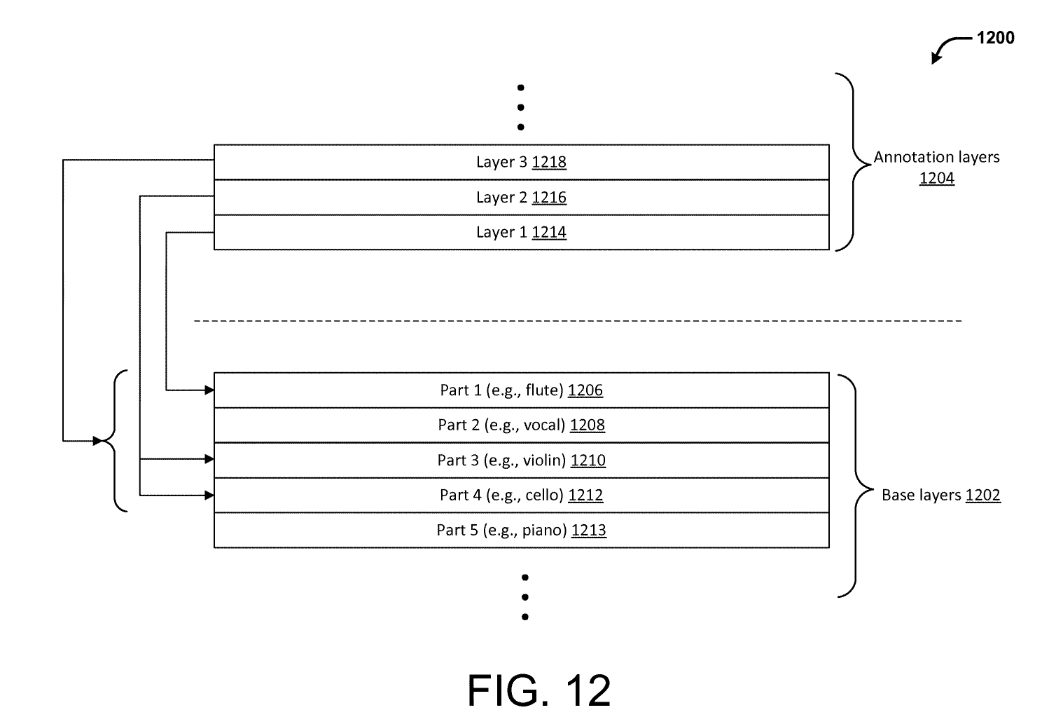

FIG. 12 illustrates another example representation of musical score information 1200, in accordance with at least one embodiment. As illustrated, an annotation layer may be associated with one or more base layers such as musical or instrumental parts. For example, annotation layer 1214 is associated with base layer 1206 (including Part 1 of a music score); annotation layer 1216 is associated with two base layers 1210 and 1212 (including Parts 3 and 4, respectively); and annotation layer 1218 is associated with four layers 1206, 1208, 1210 and 1212 (including Parts 1, 2, 3, and 4, respectively). On the other hand, a base layer such as a part may be associated with zero, one, or more annotation layers. For example, base layer 1206 is associated with two annotation layers 1214 and 1218; base layer 1208 is associated with one annotation layer 1218; base layer 1210 is associated with two annotation layers 1216 and 1218; base layer 1212 is associated with two annotation layers 1216 and 1218; and base layer 1213 is associated with no annotation layers at all.

Although annotations are illustrated as being associated (e.g., applicable to) musical parts in base layers in FIG. 12, it is understood that in other embodiments, annotation layers may also be associated with other types of base layer (e.g., dramatic commentaries). Further, annotation layers may even be associated with other annotation layers in some embodiments.

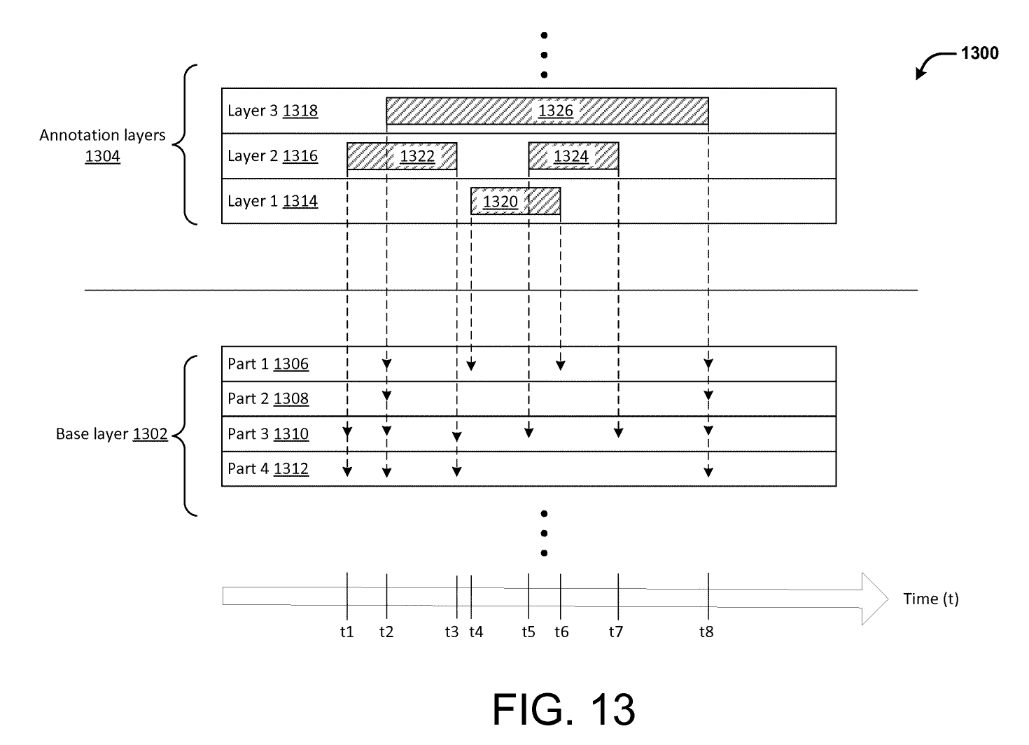

FIG. 13 illustrates another example representation of musical score information 1300, in accordance with at least one embodiment. FIG. 13 is similar to FIG. 12 except more details are provided to show the correspondence between annotations and temporal music ranges in the musical parts.

As illustrated, annotation layer 1314 includes an annotation 1320 that is associated with a music range spanning temporally from time t4 to t6 in base layer 1306 containing part 1 of a music score. Annotation layer 1316 includes two annotations. The first annotation 1322 is associated with a music range spanning temporally from time t1 to t3 in base layers 1310 and 1312 (containing Parts 3 and 4, respectively). The second annotation 1324 is associated with a music range spanning temporally from time t5 to t7 in base layer 1310 (containing Part 3). Finally, annotation layer 1318 includes an annotation 1326 that is associated with a music range spanning temporally from t2 to t8 in layers 1306, 1308, 1310 and 1312 (containing Parts 1, 2, 3 and 4, respectively).

As illustrated in this example, a music range is tied to one or more musical notes or other musical elements. A music range may encompass multiple temporally consecutive elements (e.g., notes, staves, measures) as well as multiple contemporary parts (e.g., multiple instruments). Likewise, multiple annotations from different annotation layers may apply to the same temporal music range.

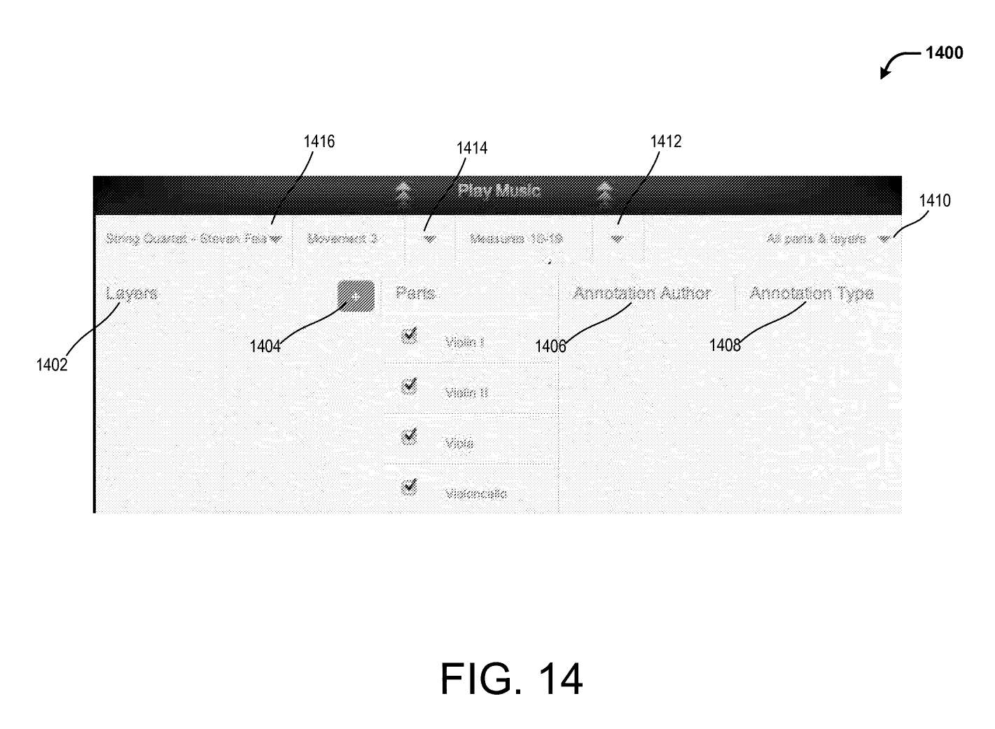

As discussed above, the MDCACE service provides a UI that allows users to control the display of musical score information as well as editing the musical score information (e.g., by providing annotations). FIGS. 14-19 illustrates various example UIs provided by the MDCACE service, according to some embodiments. In various embodiments, more, less, or different UI components than those illustrated may be provided.

In various embodiments, users may interact with the MDCACE system via touch-screen input with a finger, stylus (e.g. useful for more precisely drawing images), mouse, keyboard, and/or gestures. Such gesture-based input mechanism may be useful for conductors, who routinely gesture partially in order to communicate timings. The gesture-based input mechanism may also benefit musicians who sometimes use gestures such as a nod to indicate advancement of music scores to a page turner.

FIG. 14 illustrates an example UI 1400 provided by an MDCACE service, in accordance with at least one embodiment. In an embodiment, UI 1400 allows users to control the display of musical score information.

In an embodiment, the UI allows a user to control the scope of content displayed on a user device at various levels of granularity. For example, a user may select the music score (e.g., by selecting from a music score selection control 1416), the movement within the music score (e.g., by selecting from a movement selection control 1414), the measures within the movement (e.g., by selecting a measure selection control 1412), and the associated parts or layers (e.g., by selecting a layer selection control 1410). In various embodiments, selection controls may include a dropdown list, menu, or the like.

In an embodiment, the UI allows users to filter (e.g., show or hide) content displayed on the user device. For example, a user may control which annotation layers to display in the layer selection section 1402, which may display a list of currently available annotation layers or allow a user to add a new layer. The user may select or deselect a layer, for example, by checking or unchecking a checkbox or a similar control next to the name of the layer. Likewise, a user may control which parts to display in the part selection section 1404, which may display a list of currently available parts. The user may select or deselect a part, for example, by checking or unchecking a checkbox or a similar control next to the name of the part. In the illustrate example, all four parts of the music score, Violin I, Violin II, Viola and Violoncello, are currently selected.

A user may also filter the content by annotation authors in the annotation author selection section 1406, which may display the available authors that provided the annotations associated with the content. The user may select or deselect annotations provided by a given author, for example, by checking or unchecking a checkbox or a similar control next to the name of the author. In another embodiment, the user may select annotations from a given author by selecting the author from a dropdown list.

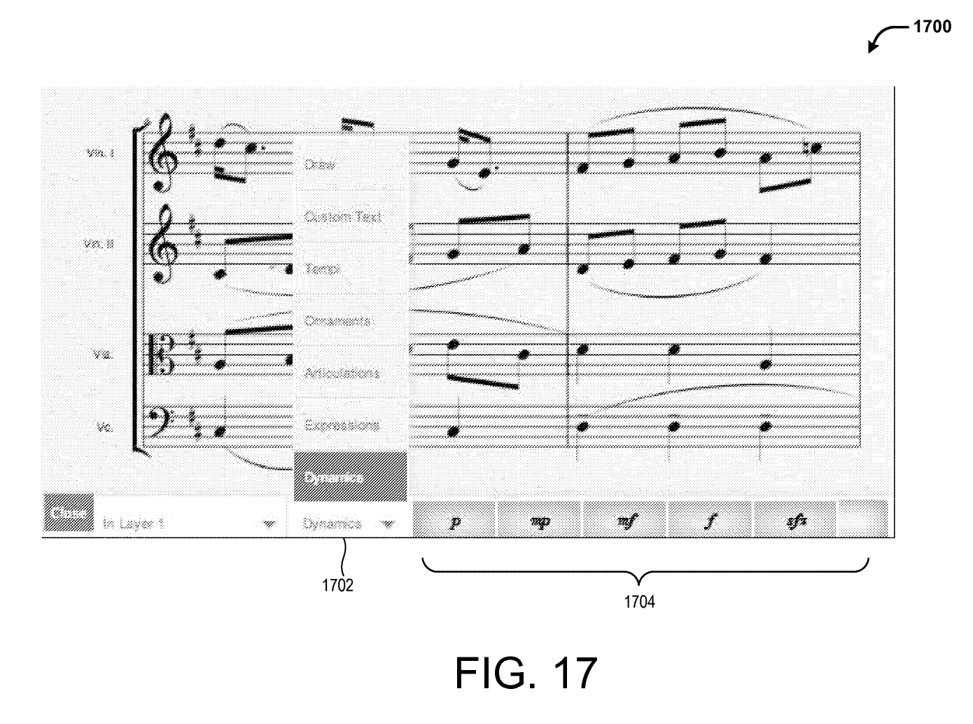

A user may also filter the content by annotation type in the annotation type selection section 1408, which may display the available annotation types associated with the content. The user may select or deselect annotations of a given annotation type, for example, by checking or unchecking a checkbox or a similar control next to the name of the annotation type. In another embodiment, the user may select annotations of a given type by selecting the type from a dropdown list. In various embodiments, annotation types may include comments (e.g., textual or non-textual), free-drawn graphics, musical notations (e.g., words, symbols) and the like. Some examples of annotation types are illustrated in FIG. 17 (e.g., “Draw,” “Custom Text,” “Tempi,” “Ornaments,” “Articulations,” “Expressions,” “Dynamics).

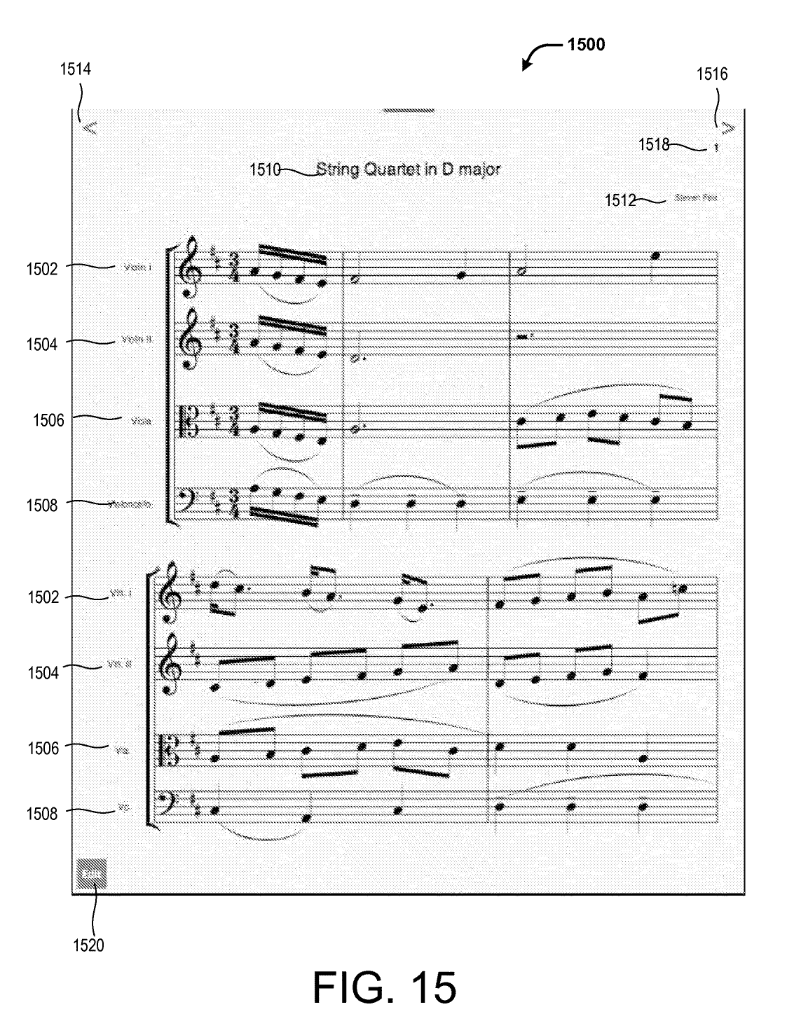

FIG. 15 illustrates an example UI 1500 provided by an MDCACE service, in accordance with at least one embodiment. In an embodiment, such a UI 1500 may be used to display musical score information as a result of the user's selections (e.g., pertaining to scope, layers, filters and the like) such as illustrated in FIG. 14.

As illustrated, UI 1500 displays the parts 1502, 1504, 1506 and 1508 and annotation layers (if any) selected by a user. Additionally, the UI 1500 displays the composition title 1510 and composer 1512 of the music score. The current page number 1518 may be displayed, along with forward and backward navigation controls 1514 and 1516, respectively, to display the next or previous page. In some embodiments, the users may also or alternatively advance music by a swipe of a finger or a gesture. Finally, the UI 1500 includes an edit control 1520 to allow a user to edit the music score, for example, by adding annotations or by changing the underlying musical parts, such as for compositional purposes.

In an embodiment, the UI allows users to jump from one score to another score, or from one area of a score to another. In some embodiments, such navigation can be performed on the basis of rehearsal marks, measure numbers, and/or titles of separate songs or musical pieces or movements that occur within one individual MDCACE file/score. For instance, users can jump to a specific aria within an opera by its title or number, or jump to a certain sonata within a compilation/anthology of Beethoven sonatas. In some embodiments, users can also “hyperlink” two areas of the score of his choosing, allowing the user to advance to location Y from location X with just one tap/click. In some other embodiments, users can also link to outside content such as websites, files, multimedia objects and the like.

With regard to the display of musical scores, in an embodiment, the design of the UI is minimalist, so that the music score can take up the majority of the screen of the device on which it is being viewed and can evoke the experience of working with music as directly as possible.

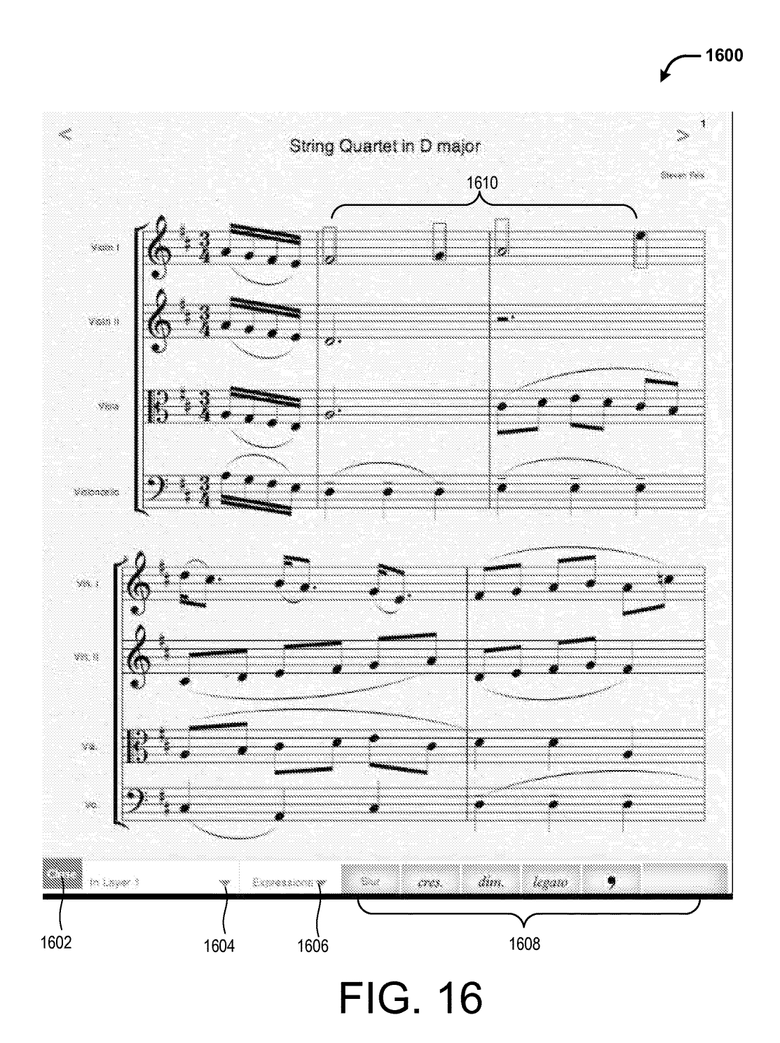

FIG. 16 illustrates an example UI 1600 provided by an MDCACE service, in accordance with at least one embodiment. FIG. 16 is similar to FIG. 15 except that UI 1600 allows a user to provide annotations, additions, or modifications to a music score. The UI 1600 may be displayed upon indication of a user to edit the music score, for example, by selecting the edit control 1520 illustrated in FIG. 15. The user may go back to the view illustrated by FIG. 15, for example, by clicking on the “Close” button 1602.

As illustrated, UI 1600 displays the musical score information (e.g., parts, annotations, title, author, page number, etc.) similar to the UI 1500 discussed in connection with FIG. 15. Additionally, UI 1600 allows users to add annotations or make other modifications to a layer. The layer may be an existing layer previously created. A user may select such an annotation layer, for example, by selecting a layer from a layer selection control 1604 (e.g., a dropdown list). In some embodiments, a user may have the option to create a new layer and add annotations to it. In some embodiments, access control policies or rules may limit the available annotation layers to which a given user may add annotations. For example, in an embodiment, a user may be allowed to add annotations only to annotation layers created by the user.

In some embodiments, users may create annotations or other modifications first and then add them to a selected music range (e.g., horizontally across some number of notes or measures temporally, and/or vertically across multiple staves and/or multiple instrument parts). In some other embodiments, users may select the music range first before creating annotations or modifications associated with the music range. In yet some other embodiments, both steps may be performed at substantially the same time. In all these embodiments, the annotations or modifications are understood to apply to the selected musical note or notes, to which they are linked.

In an embodiment, a user may create an annotation or modification by first selecting a predefined annotation or modification type, for example, from an annotation or modification type selection control (e.g., a dropdown list) 1606. Based on the selected annotation or modification type, a set of predefined annotations or modifications of the selected annotation or modification type may be provided for the user to choose from. For example, as illustrated, when the user selects “Expressions” as the annotation or modification type, links 1608 to a group of predefined annotations or modifications pertaining to music expressions may be provided. A user may select one of the links 1608 to create an expression annotation or modification. In some embodiments, a drag-and-drop interface may be provided wherein a user may drag a predefined annotation or modification (e.g., with a mouse or a finger) and drop it to the desired location in the music score. In such a case, the annotation or modification would be understood by the system to be connected to some specific musical note or notes.

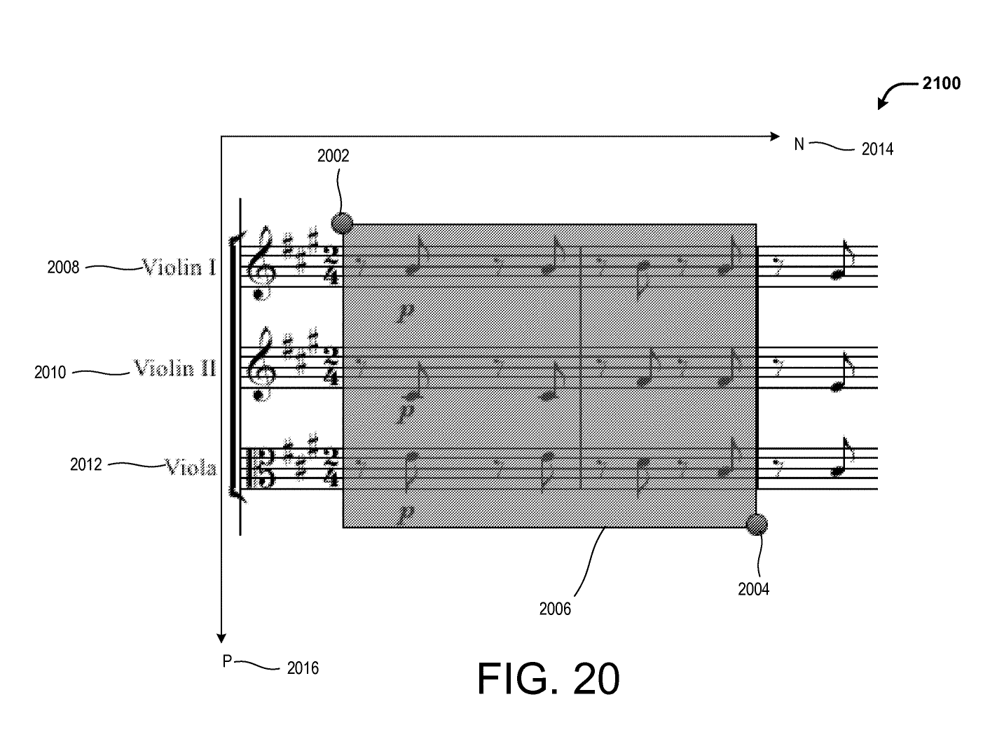

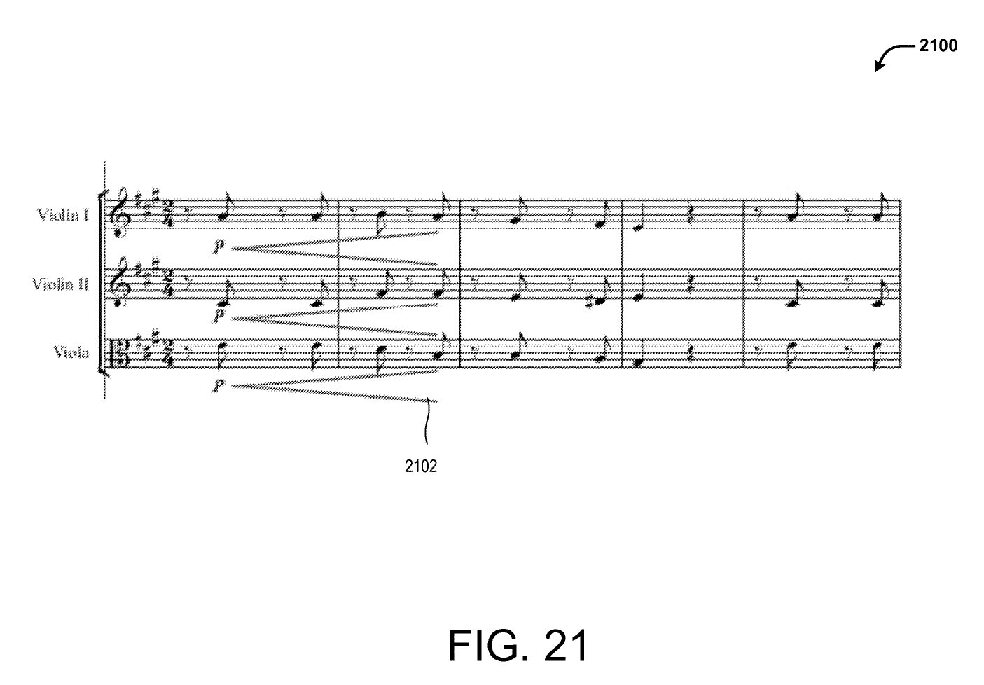

As discussed above, a music range may encompass temporally consecutive musical elements (e.g., notes or measures) or contemporary parts or layers (e.g., multiple staves within an instrument, or multiple instrument parts). Various methods may be provided for a user to select such a music range, such as discussed in connection with FIG. 20 below. In an embodiment, musical notes within a selected music range may be highlighted or otherwise emphasized (such as illustrated by the rectangles surrounding the notes within the music range 1610 of FIG. 16 or 2006 of FIG. 20). In an embodiment, after a user selects or creates an annotation or modification and applies it to a selected music range, the annotations or modifications are displayed with the selected music range, such as illustrated in FIG. 21.

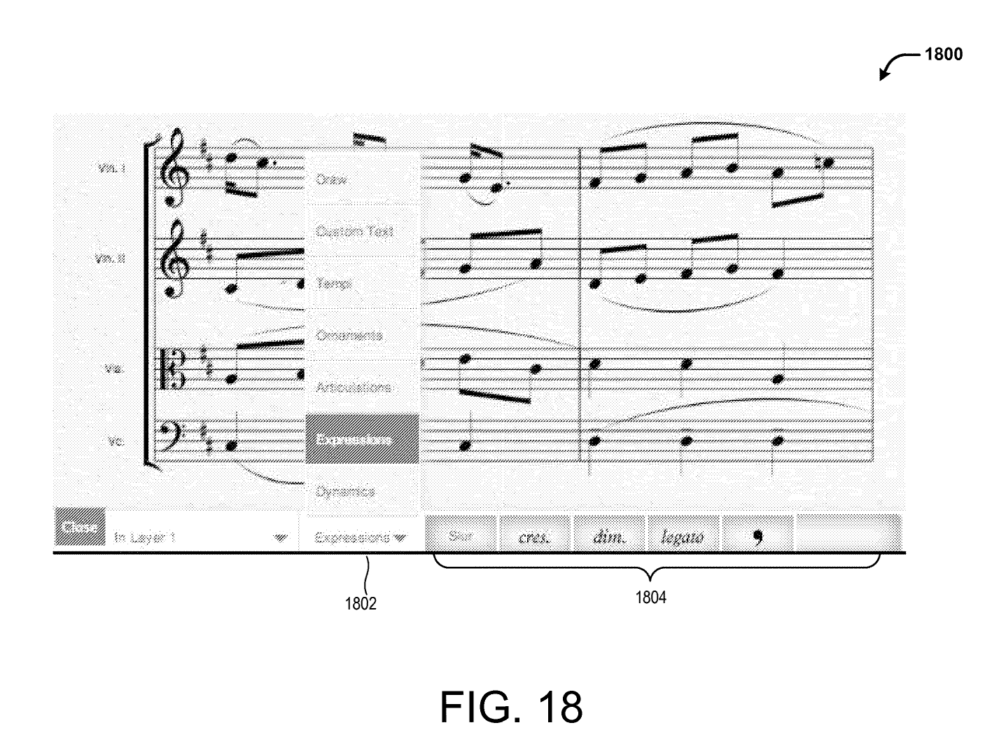

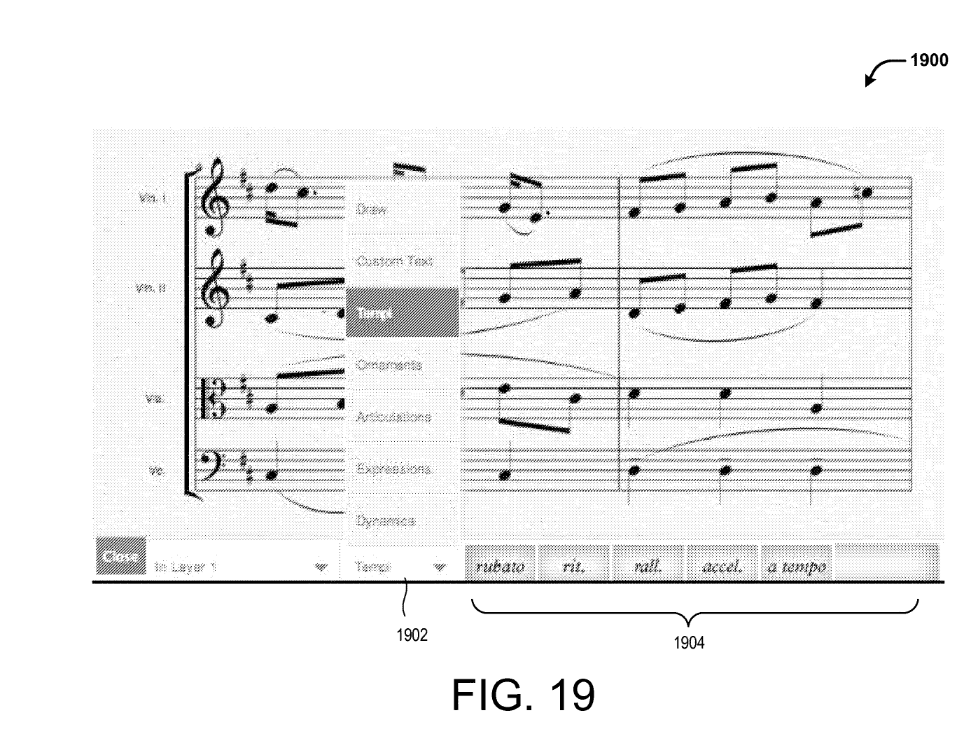

FIGS. 17-19 illustrates example UIs, 1700, 1800 and 1900, showing example annotation or modification types and example annotations or modifications associated with the annotation or modification types, in accordance with at least one embodiment. FIGS. 17-19 are similar to FIG. 16 except the portion of the screen for annotation or modification selection is shown in detail. In an embodiment, predefined annotation or modification types includes dynamics, expressions, articulations, ornaments, tempi, custom text and free-drawn graphics, such as shown under the annotation type selection control 1606, 1702, 1802 and 1902 of FIGS. 16, 17, 18 and 19, respectively. FIG. 17 illustrates example annotations or modifications 1704 associated with dynamics. FIG. 18 illustrates example annotations or modifications 1804 associated with musical expressions. FIG. 19 illustrates example annotations or modifications 1904 associated with tempi.

FIG. 20 illustrates an example UI 2100 for selecting a music range for which an annotation or modification applies, in accordance with at least one embodiment. As illustrated, a music range 2006 may encompass one or more temporally consecutive musical elements (e.g., notes or measures) and/or one or more parts 2008, 2010, 2012.

In an embodiment, a user selects and holds with an input device (e.g., mouse, finger, stylus) at a start point 2002 on a music score, then holds and drags such input device to an end point 2004 on the music score (which could be a different note in the same part, the same note temporally in a different part, or a different note in a different part). The start point and the end point collectively define an area and musical notes within the area are considered as being within the selected music range. For illustrative purposes, the coordinates of the start point and end point may be expressed as (N, P) in a two-dimensional system, where N 2014 represents the temporal dimension of the music score and P 2016 represents the parts.

If a desired note is not shown on the screen at the time the user starts to annotate or otherwise modify the score, the user can drag his input device to the edge of the screen, and more music may appear such that the user can reach the last desired note. If the user drags to the right of the screen, more measures will enter from the right, i.e., the music will scroll left, and vice versa. Once the last desired note is included in the selected range, the user may release the input device at the end point 2004. Additionally or alternatively, a user may select individual musical notes within a desired range.

As discussed above, once a user selects or creates an annotation or modification and applies it to a selected music range (or vice versa), the annotations or changes are displayed with the selected music range as part of the layer that includes the annotation or otherwise reflects the modification. In some embodiments, annotations or modifications are tied to or anchored by musical elements (e.g., notes, measures), not spatial positions in a particular rendering. As such, when a music score is re-rendered (e.g., due a change in zoom level or size of a display area or display of an alternate subset of musical parts), the associated annotations or modifications are adjusted correspondingly.

FIG. 21 illustrates an example UI 2100 showing annotations or modifications applied to a selected music range, in accordance with at least one embodiment. Such a music range may be similar to the music range 2006 illustrated in FIG. 20. In this example, an annotation or addition of a crescendo symbol 2102 is created and applied to the music range. In particular, the symbol 2102 is shown as applied to both the temporal dimension of the selected music range and the several parts encompassed by the selected music range.

In some cases, a user may wish to annotate or modify a subset of the parts or temporal elements of a selected music range. In such cases, the UI may provide options to allow the users to select the desired subset of parts and/or temporal elements (e.g., notes or measures), for example, when an annotation is created (e.g., from an annotation panel or dropdown list).

In an embodiment, annotations or other score additions are anchored at the note the user selects when making an annotation or other score addition. The note's pixel location is responsible for dictating the physical placement of the annotation or added element. In some embodiments, should the annotation or element span over a series of notes, the first or last note (in the first or last part, if there are multiple parts) selected function as the anchors. In some embodiments, even if the shown parts of the music change or the location on the screen of the relevant passages of music changes, or if system break or page break changes, the annotations or additions will still be associated with their anchors and therefore be drawn in the correct musical locations. Such will remain even as musical notes are updated to reflect corrections of publishing editions or new editions thereof. In some embodiments, should the change affects a note that has been previously modified in a conflicting manner, a user may be alerted to that change and asked whether the annotation or modification should be preserved, deleted, or changed.

In some embodiments, annotations or additions may be automatically generated and/or validated based on the annotation or modification types. For example, fermatas are typically applied across all instruments, because they correspond to the length of the notes to which fermatas are applied. Thus, if a user adds a fermata to a particular note for one part, the system may automatically add fermatas to all other parts at the same temporal note.

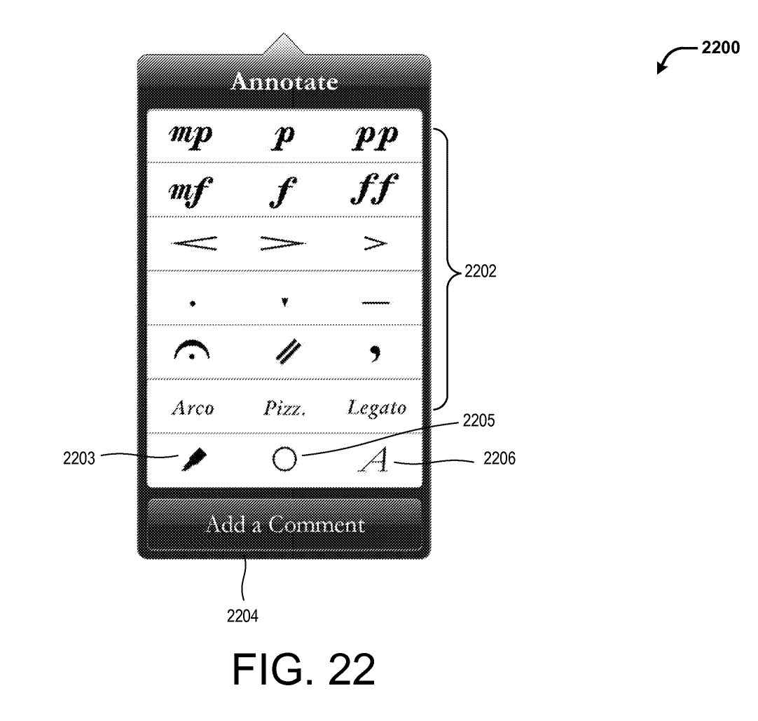

FIG. 22 illustrates an example annotation or modification panel 2200 for providing an annotation or modification, in accordance with at least one embodiment. As illustrated, the annotation or modification panel 2200 includes a number of predefined musical notations 2202 (including symbols and/or letters). A user may select any of predefined musical notations 2202 using an input device such as a mouse, stylus, finger or even gestures. The panel 2200 may also include controls that allow users to create other types of annotations such as free-drawn graphics or highlight (e.g., via control 2203), comment (e.g., via control 2204), blocking or staging directions (e.g., via control 2206), circle or other shapes (e.g., via control 2005), and the like.

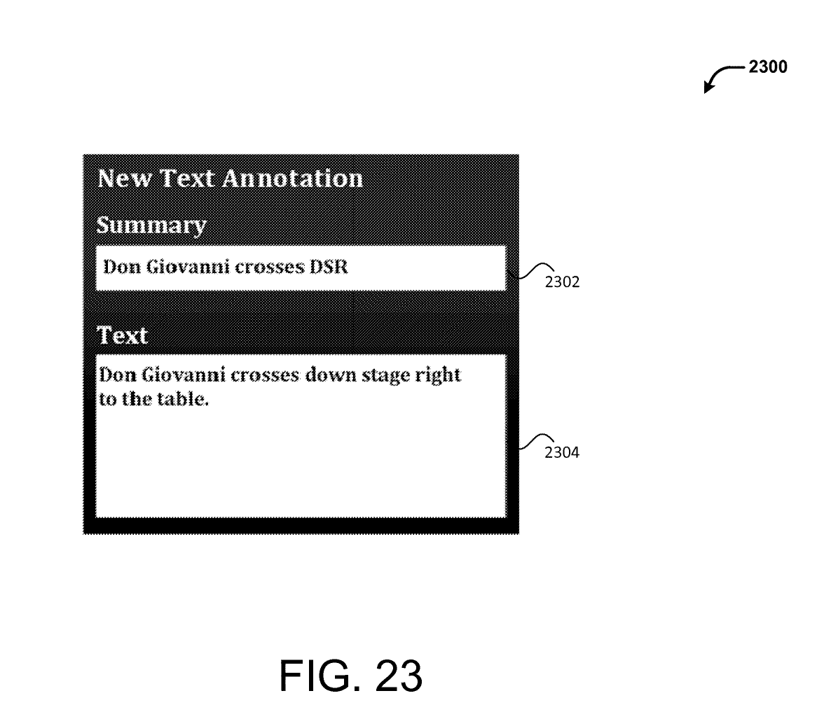

FIG. 23 illustrates an example text input form 2300 for providing textual annotations or modifications, in accordance with at least one embodiment. In an embodiment, such a text input form 2300 may be provided when a user selects “Custom Text” using the annotation or modification type selection control 1702 of FIG. 17 or “Add a Comment” button 2204 in FIG. 22.

As illustrated, the text input form 2300 includes a “Summary” field 2302 and a “Text” field 2304, each may be implemented as a text field or text box configured to receive text. Text contained in either or both fields may be displayed as annotations (e.g., separately or concatenated) when the associated music range is viewed. Similarly, in an embodiment of the invention, the text in the “Summary” field may be concatenated with that in the “Text” field as two combined text strings, for more rapid input of text that is nonetheless separable into those two distinct components.

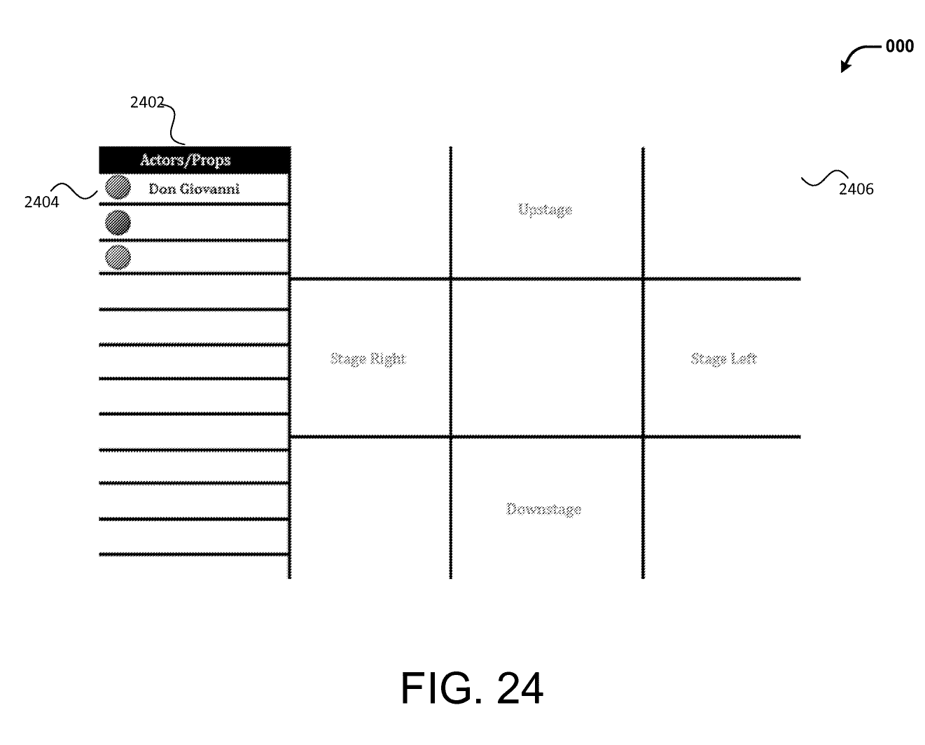

FIGS. 24-26 illustrate example UIs 2400, 2500 and 2600 for providing staging directions, in accordance with some embodiments. In an embodiment, such UIs may be provided when a user selects the blocking or staging directions control 2206 in FIG. 22.

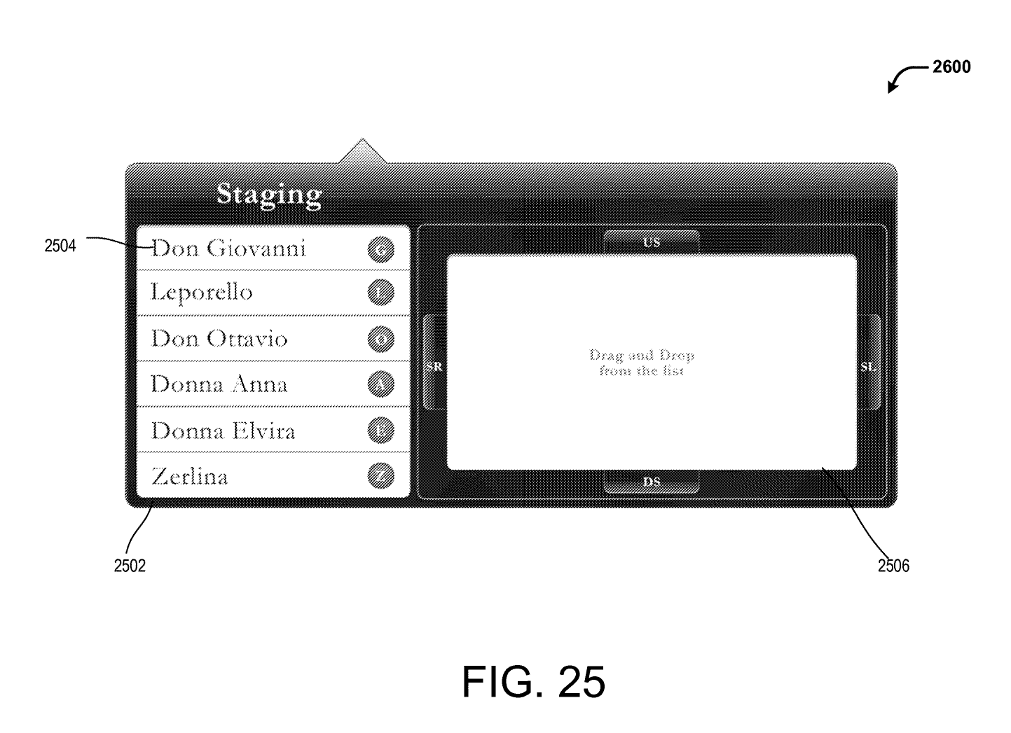

As illustrated by FIG. 24, the UI 2400 provides object section 2402, which may include names and/or symbols 2404 representing singers, props or other entities. The UI 2400 also includes a stage section 2406, which may be divided into multiple sub-quadrants or grids (e.g., Up-Stage Center, Down-Stage Center, Center-Stage Right, Center-Stage Left). For a first temporal point in the music score, users may drag or somehow place symbols 2404 for singers or other objects onto the stage section 2406, thereby indicating the locations of such objects on the stage at that point in time. FIG. 25 illustrates another example UI 2500 that is similar to UI 2400 of FIG. 24. Like UI 2400, the UI 2500 provides an object section 2502, which may include names and/or symbols 2504 representing singers, props or other movable entities. The UI 2500 also includes a stage section 2506, which may be divided up into multiple sub-quadrants or grids.

At a later second temporal point, users may again indicate the then-intended locations of the objects on stage using the UI 2400 or 2500. Some of the objects have changed locations between the first and second temporal points. Such changes may be automatically detected (e.g., by comparing the location of the objects between the first and second temporal points). Based on the detected change, an annotation of staging direction may be automatically generated and associated with the second temporal point. In some embodiments, the detected change is translated into a vector (e.g., from up-stage left to down-stage right, which represents a vector in the direction of down-stage right), which is then translated into a language-based representation.

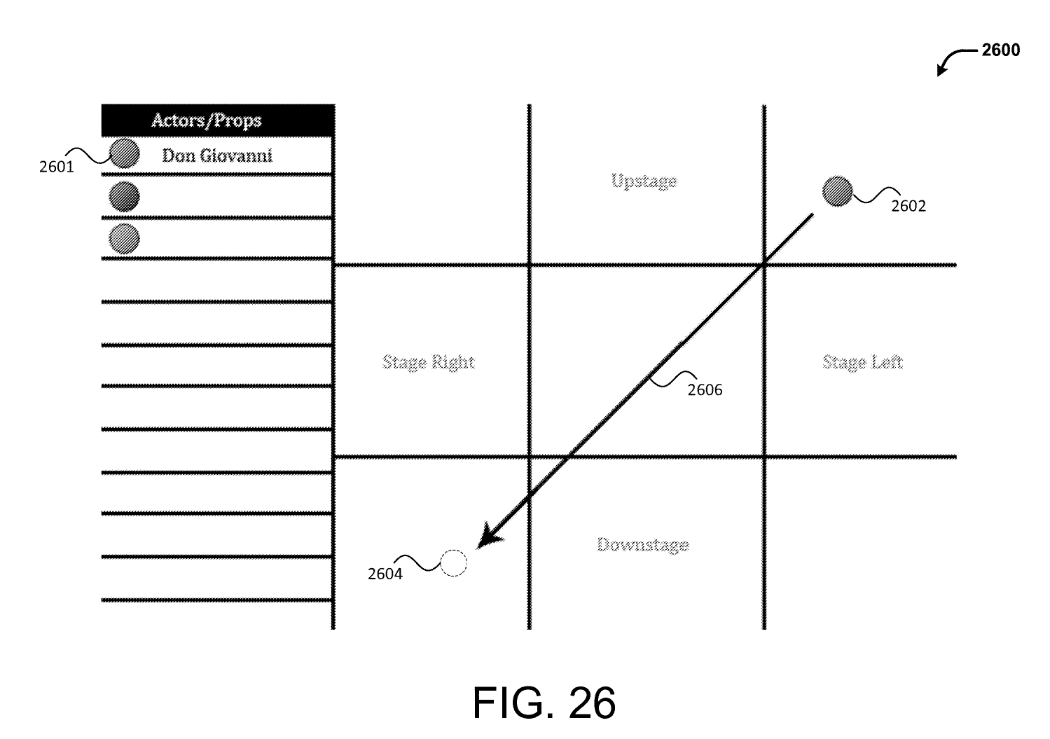

As illustrated by FIG. 26, singer Don Giovanni moves from a first location 2602 (e.g., Up-Stage Left) at a first temporal point to a second location 2604 (e.g., Down-Stage Right) at a second temporal point. In some embodiments of the invention, a stage director may associate a first annotation showing the singer at the first location 2602 with a musical note near the first temporal point and a second annotation showing the singer at the second location 2604 with a musical note near the second temporal point. The system may detect the change in location (as represented by the vector 2606) by identifying people on stage that are common between the two annotations, e.g., Don Giovanni, and determining whether such people had a position change between the annotations. If such a location change is detected, the change vector 2606 may be obtained and translated to a language-based annotation, e.g., “Don Giovanni crosses from Up-Stage Left to Down-Stage Right.” The annotation may be associated with the second temporal point or a temporal point slightly before the second temporal point, so that the singer knows the staging directions beforehand. In other embodiments, the vector may be translated a graphical illustration, an audio cue, or other types of annotation and/or output.

In an example, directors can input staging blocking or directions for the singers which are transmitted to the singers in real-time. Advantageously, the singers do not need to worry about writing these notes during rehearsal, as somebody else can write them and they appear in real-time. Each blocking instruction can be directed to only those who need to see that particular instruction. In some embodiments of the invention, such instructions are tagged to apply to individual users, such that users can filter on this basis.

As discussed above, a user may also enter free-drawn graphics as annotations or additions to a score. In some embodiments, users may use a finger, stylus, mouse, or another input device to make a drawing on an interface provided by the MDCACE service. The users may be allowed to choose the colors, thickness of pen, and other characteristics of the drawing. The pixel data of each annotation (including but not limited to the color, thickness, and x and y coordinate locations) is then converted to a suitable vector format such as Scalable Vector Graphics (SVG) for storage in the database. After inputting a graphic, the user can name the graphics so that the graphics can be subsequently reused by the same or different users without the need to re-draw the graphics. The drawing may be anchored at a selected anchor position. Should the user change their view (e.g. zooming in, rotating tablet, removing or adding parts), the anchor position may change. In such cases, the image size may be scaled accordingly.

Besides adding annotations and making other modifications as described above, users may also be allowed to remove, edit, or move around existing layers, annotations, and the like. The users' ability to modify such musical score information may be controlled by access control rules associated with the annotations, layers, music scores or the like. In some cases, the accessed control rules may be configurable (e.g., by administrator and/or users) or provided by default.

According to another aspect of the invention, musical score information may be displayed in a continuous manner, for example, to facilitate the continuity and/or readability of the score. Using a physical music score, a pianist may experience a moment of blindness or discontinuity when he cannot see music from both page X and X+1, if these pages are located on opposite sides of the same sheet of paper. One way to solve the problem is to display multiple sections of the score at once where each section advances at different time so as to provide overlap between temporally consecutive displays, thereby removing the blind spot between page turns.

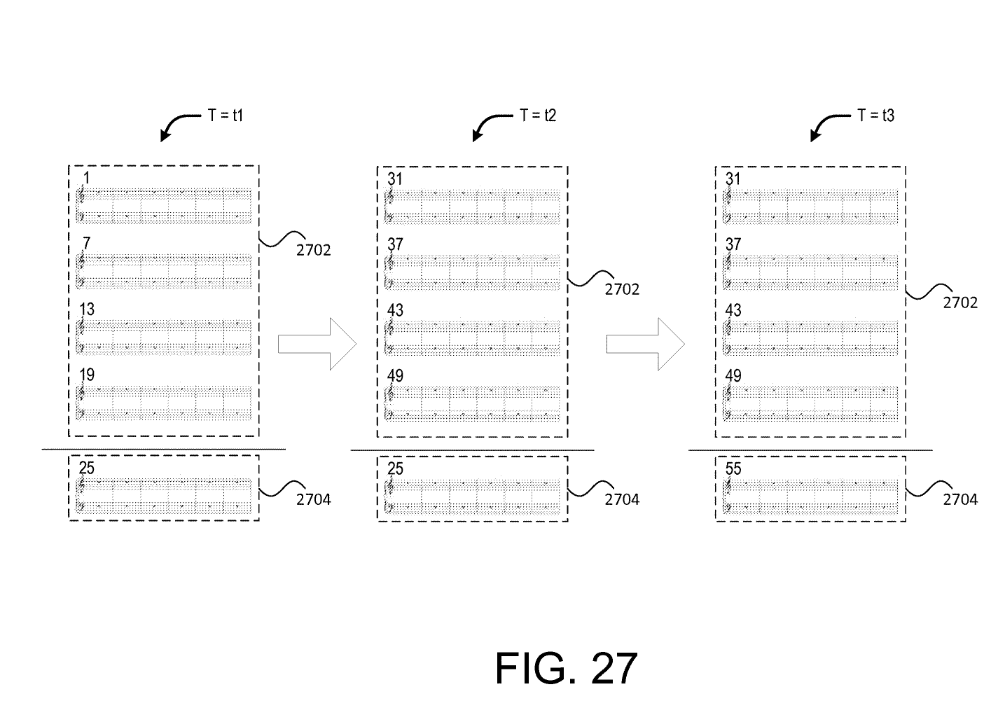

FIG. 27 illustrates example UIs for providing continuous display of musical scores, in accordance with at least one embodiment. In an embodiment, the UI is configured to display S (S is any positive integer such as 5) systems of music at any given time. A system may correspond to a collection of measures, typically arranged on the same line. For example, System 1 may start at measure 1 and end at measure 6; System 2 may start at measure 7 and ends at measure 12; System 3 may start at measure 13 and ends at measure 18, and so on. The UI may be divided into two sections wherein one section displays systems 1 through S−1 while the other displays just system S. The sections may be advanced at different time so as to provide temporal overlaps between the displays of music. The separation between the sections may be clearly demarcated.

In the illustrated embodiment, music shown on a screen at any given time is divided into two sections 2702 and 2704 that are advanced at different times. At time T=t1, the UI displays the music from top to bottom showing systems starting at measures 1, 7, 13 and 19, respectively, in the top section 2702 and system starting at measure 25 in the bottom section 2704. At time T=t2, when the user reaches the music in the lower section 2704 (e.g., system starting at measure 25), for example, during her performance, the top section 2702 is may be advanced to the next portions of the music score (systems starting at measures 31, 37, 43, and 49, respectively) while the advancement for the bottom section 2704 is delayed for a period of time (thus still showing the system starting at measure 25). Note there is an overlap of content in section 2704 (i.e., system starting at measure 25) between consecutive displays at t1 and at t2, respectively. As the user continues playing and reaches the bottom of the top section 2702 (system starting at measure 49), the lower section 2704 may be advanced to show the next system (starting at measure 55) while the top section 2702 remains the unchanged. Note there is an overlap of content between consecutive displays at t2 and t3 (i.e., the systems in the top section 2702). In various embodiments, the top section and the bottom section may be configured to display more or less numbers of systems than that illustrated here. For example, the bottom section may be configured to display two or more than two systems at a time, or there might be more than two sections.

In some embodiment, the display of the music score may be mirrored on master device (e.g., a master computer) operated by a master user such as a conductor, an administrator, a page turner, a composer, or the like. The master user may provide, via the master device, page turning service to the users devices connected to the master device. For example, the master user may turn or scroll one of the sections 2702 or 2704 (e.g., by a swipe of finger) according to the progression of a performance or rehearsal, while the other section remains unchanged. For example, when the music reaches the system starting at measure 25, the master user may advance the top section 2702 as shown in t2, and when the music reaches the system starting at measure 49, the master user may advance the bottom section 2704. The master user's actions may be reflected on the other users' screen so that the other users may enjoy the page turning service provided by the master user. In some embodiments, the user might communicate the advancement of a score on a measure-by-measure level, for instance by dragging a finger along the score or tapping once for each advanced measure, in order that the individuals scores of individual musicians advance as sensible for those musicians, even if different ranges of measures or different arrangements of systems are shown on the individual display devices of those different musicians. In other words, based on the master user's indications or commands, each individual user's score may be advanced appropriately based on his or her own situation (e.g., instrument played, viewing device parameters, zoom level, or personal preference).

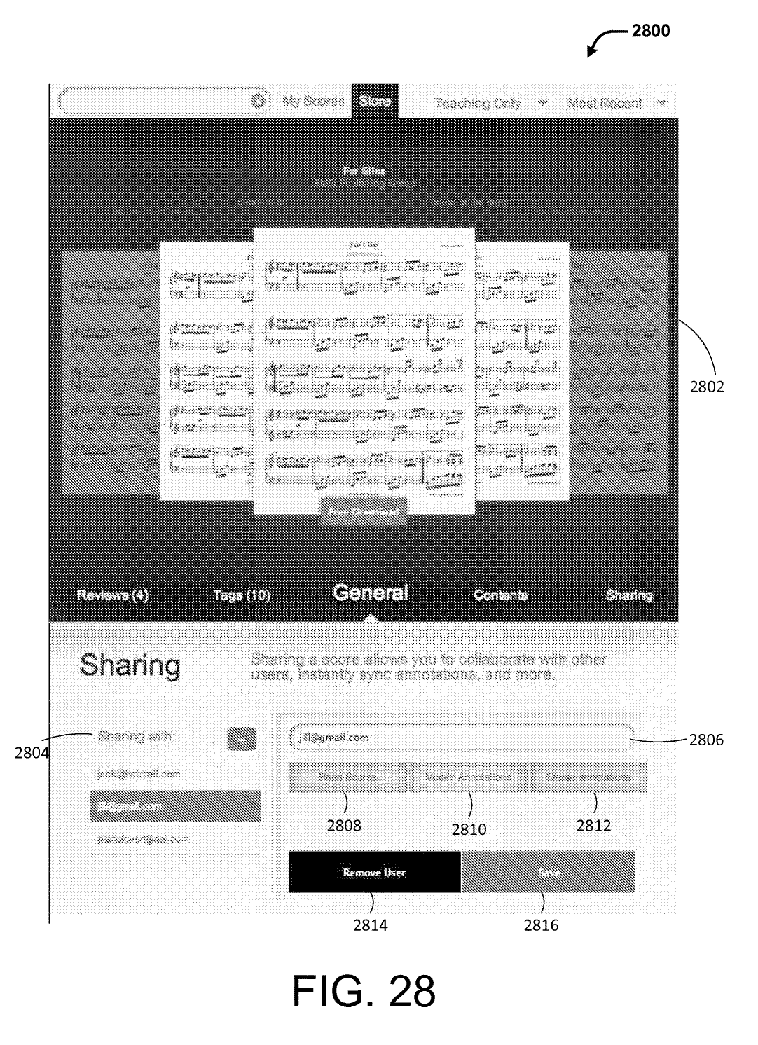

In some embodiments, musical score information described herein may be shared to facilitate collaboration among users of the MDCACE service. FIG. 28 illustrates an example UI 2800 for sharing musical score information, in accordance with at least one embodiment. As illustrated, the UI 2800 provides a score selection control 2802 for selecting the music score to share. The score selection control 2802 may provide a graphical representation of the available scores such as illustrated in FIG. 28, a textual list of scores, or some other interface for selecting a score. A user may add one or more users to share the music score with, for example, by adding their information (e.g., username, email address) in the user box 2806. A user may configure the permission rights of an added user. For example, the added user may be able to read the score (e.g., if the “Read Scores” control 2808 is selected), modify annotations (e.g., if the “Modify Annotations” control 2810 is selected), and create new annotations (e.g., if the “Create annotations” control 2812 is selected). A user may save permission settings for an added user, for example, clicking on the “Save” button 2816. The saved user may then appear under the “Sharing with” section 2804. A user may also remove users previously added, for example, by clicking on the “Remove User” button.

In various embodiments, sharing a music score may cause the music score to appear as visible/editable by the shared users. In some embodiments, the shared information may be pushed to the shared users' devices, email inboxes, social networks and the like. In some embodiments, musical score information (including the score and annotations) may also be saved, printed, exported, or otherwise processed.

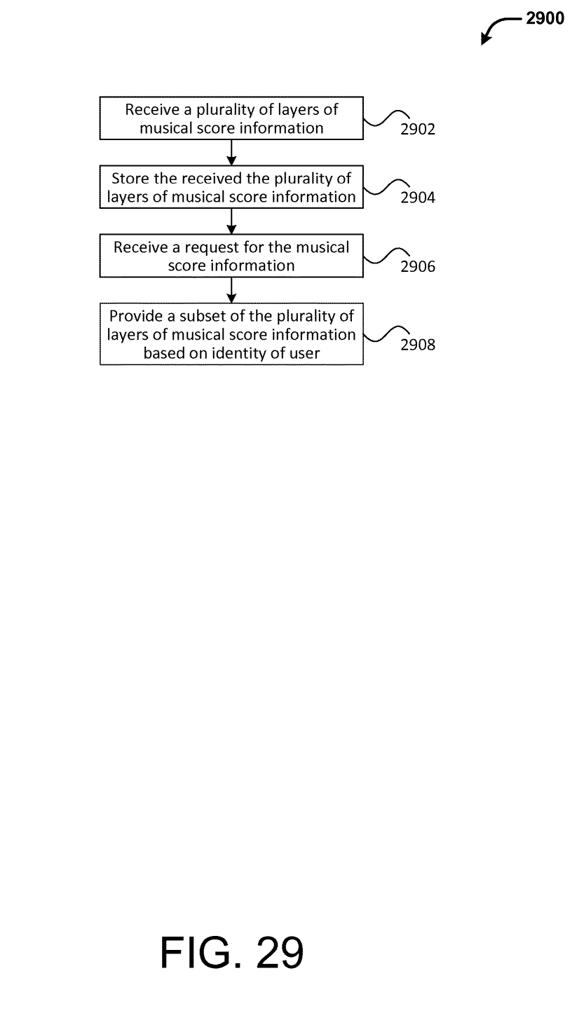

FIG. 29 illustrates an example process 2900 for implementing an MDCACE service, in accordance with at least one embodiment. Aspects of the process 2900 may be performed, for example, by a MDCACE backend 110 discussed in connection with FIG. 1 or a computing device 900 discussed in connection with FIG. 9. Some or all of the process 2900 (or any other processes described herein, or variations and/or combinations thereof) may be performed under the control of one or more computer/control systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The order in which the operations are described is not intended to be construed as a limitation, and any number of the described operations may be combined in any order and/or in parallel to implement the processes.

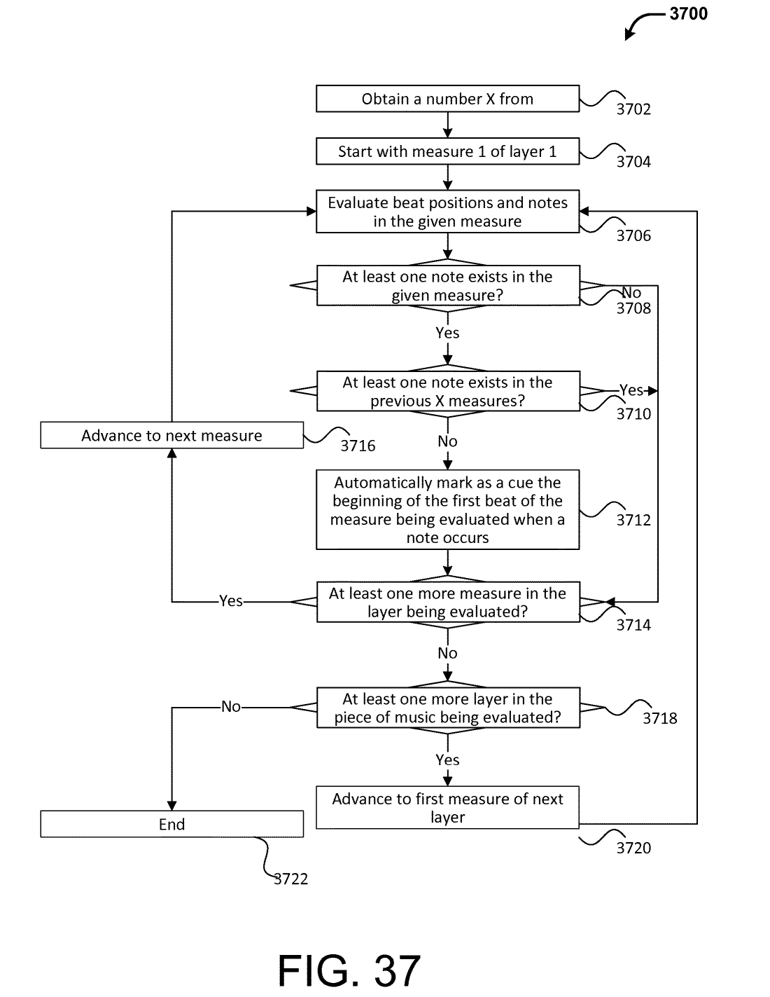

In an embodiment, process 2900 includes receiving 2902 a plurality of layers of musical score information. The musical score information may be associated with a given musical score. The plurality of layers may include base layers of the music score, system-generated annotation layers and/or user-provided annotation layers as described above. In various embodiments, the various layers may be provided over a period of time and/or by different sources. For example, the base layers may be provided by a music score parser or similar service that generates such base layers (e.g., corresponding to each parts) based on traditional musical scores. The system-generated annotation layers may be generated by the MDCACE service based on the base layers or imported from third-party service providers. Such system-generated annotation layers may include an orchestral cue layer that is generated according to process 3700 discussed in connection with FIG. 37. The user-provided annotation layers may be received from user devices implementing the frontend logic of the MDCACE service. Such user-provided annotation layers may be received from one or more users. In various embodiments, the MDCACE service may provide one or more user interfaces or application programming interfaces (“APIs”) for receiving such layers, or for other service providers to build upon MCDA APIs in order to achieve individual goals.

In an embodiment, the process 2900 includes storing 2904 the received layers in, for example, a remote or local server data store such as illustrated in FIGS. 1-7. In some embodiments, the received layers may be validated, synchronized or otherwise processed before they are stored. For example, where multiple users provide conflicting annotation layers, the conflict may be resolved using a predefined conflict resolution algorithm.

As another example, one given user might annotate or otherwise mark a note asp, for piano, or soft, whereas another might mark it f, for forte, or loud. These annotations are contradictory. The system will examine such contradictions using a set of predefined conflict checking rules. One such conflict checking rule may be that a conflict occurs when there is more than one dynamic (e.g., pppp, ppp, pp, p, mp, n, mf, f, ff, fff, ffff) associated with a given note. Indications of such conflict may be presented to users, as annotations, alerts, messages or the like. In some embodiments, users may be prompted to correct the conflict. In one embodiment, the conflict may be resolved by the system using conflict resolution rules. Such conflict resolution rules may be based on the time the annotations are made, the rights or privileges of the users, or the like.

In an embodiment, the process 2900 includes receiving 2906 a request for the musical score information. Such a request may be sent, for example, by a frontend implemented by a user device in response to a need to render or display the musical score information on the user device. As another example, the request may include a polling request from a user device to obtain the new or updated musical score information. In various embodiments, the request may include identity information of the user, authentication information (e.g., username, credentials), indication of the sort of musical score information requested (e.g., the layers that the user has read access to), and other information.

In response to the request for musical score information, a subset of the plurality of layers may be provided 2908 based on the identity of the requesting user. In some embodiments, a layer may be associated with a set of access control rules. Such rules may dictate the read/write permissions of users or user groups associated with the layer and may be defined by users (such as illustrated in FIG. 11) or administrators. In such embodiments, providing the subset of layers may include selecting the layers to which the requesting user has access. In various embodiments, the access control rules may be associated with various musical score objects at any level of granularity. For example, access control rules may be associated with a music score, a layer or a component within a layer, an annotation or the like. In a typical embodiment, the access control rules are stored in a server data store (such as server data store 112 shown in FIG. 1). However, in some cases, some or all of such access control rules may be stored in a MDCACE frontend (such as MDCACE frontend 104 discussed in connection with FIG. 1), a client data store (such as a client data store 218 connected to a master user device 214 as shown in FIG. 2), or the like.

In some embodiments, providing 2908 the subset of layers may include serializing the data included in the layers into one or more files of the proper format (e.g., MusicXML, JSON, or other proprietary or non-proprietary format, etc.) before transmitting the files to the requesting user (e.g., in an HTTP response).

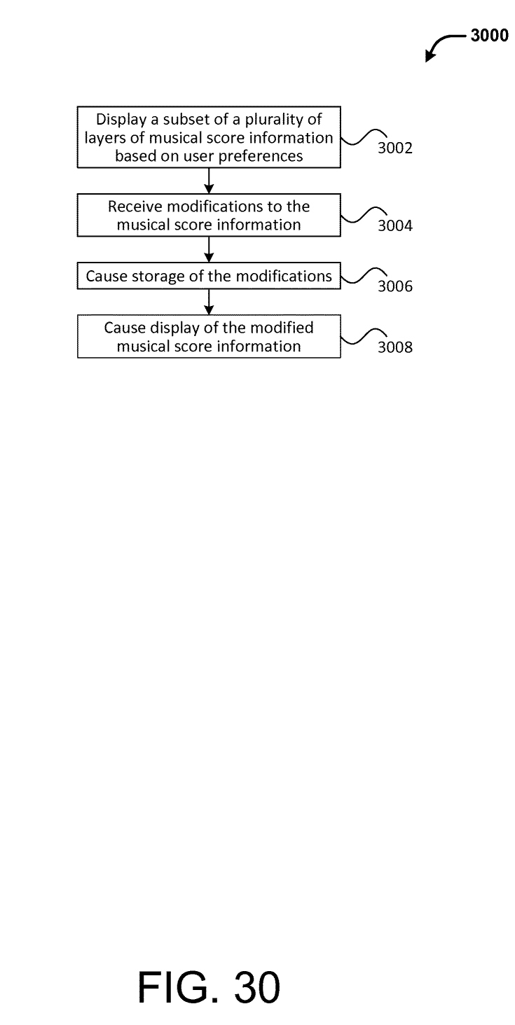

FIG. 30 illustrates an example process 3000 for implementing an MDCACE service, in accordance with at least one embodiment. Aspects of the process 3000 may be performed, for example, by a MDCACE frontend 104 discussed in connection with FIG. 1 or a computing device 900 discussed in connection with FIG. 9.

In an embodiment, process 3000 includes displaying 3002 a subset of a plurality of layers of musical score information based on user preferences. As discussed in connection with FIG. 11, users may be allowed to show and/or hide a layer such as a base layer (e.g., containing a part) or an annotation layer. In addition, users may be allowed to associate different colors with different layers and/or components within layers to provide better readability with respect to the music score. Such user preferences may be stored on a device implementing the MDCACE frontend, a local data store (such as a client data store 218 connected to a master user device 214 as shown in FIG. 2), a remote data store (such as server data store 112 shown in FIG. 1), or the like.

In some embodiments, user preferences may include user-applied filters or criteria such as with respect to the scope of the music score to be displayed, annotation types, annotation authors and the like, such as discussed in connection with FIG. 14. In some embodiments, the display 3002 of musical score information may be further based on access control rules associated with the musical score information, such as discussed in connection with step 2908 of FIG. 29.

In an embodiment, process 3000 includes receiving 3004 modifications to the musical score information. Such modifications may be received via a UI (such as illustrated in FIG. 16) provided by the MDCACE service. In some embodiments, modifications may include adding, removing or editing layers, annotations or other objects related to the music score. A user's ability to modify the musical score information may be controlled by the access control rules associated with the material being modified. Such access control rules may user-defined (such as illustrated in FIG. 11 or provided by default). For example, base layers associated with the original musical score (e.g., parts) are typically read-only by default, whereas annotation layers may be editable depending on user configurations of access rights or rules associated with the layers.

In an embodiment, process 3000 includes causing 3006 the storage of the above-discussed modifications to the musical score information. For example, modified musical score information (e.g., addition, removal or edits of layers, annotations, etc.) may be provided by an MDCACE frontend to an MDCACE backend and eventually to a server data store. As another example, the modified musical score information may be saved to a local data store (such as a client data store 218 connected to a master user device 214 as shown in FIG. 2).

In an embodiment, process 3000 includes causing 3008 the display of the above-discussed modified musical score information. For example, the modified musical score information may be displayed on the same device that initiates the changes such as illustrated in FIG. 21. As another example, the modified musical score information may be provided to user devices other than the user device that initiated the modifications (e.g., via push or pull technologies or a combination of both). Hence, the modifications or updates to musical scores may be shared among multiple user devices to facilitate collaboration among the users.

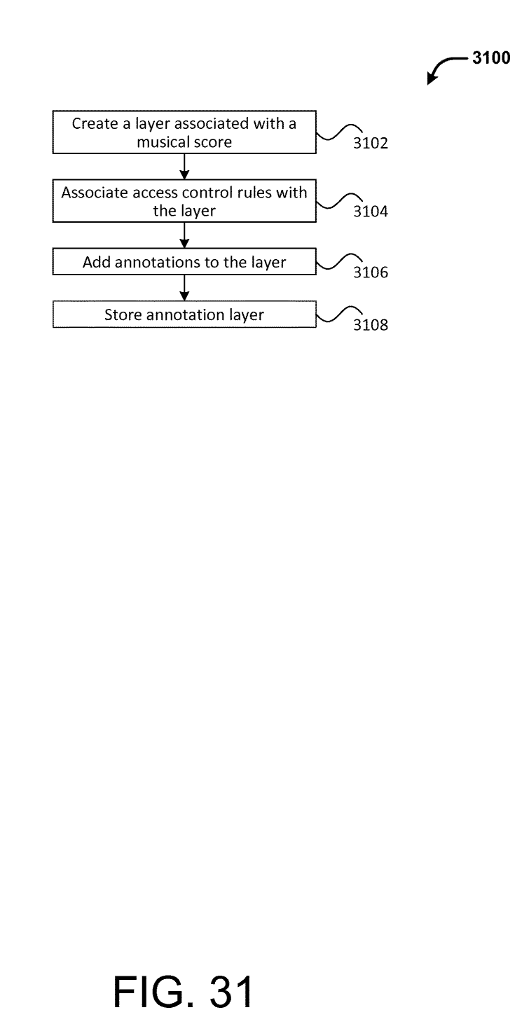

FIG. 31 illustrates an example process 3100 for creating an annotation layer, in accordance with at least one embodiment. Aspects of the process 3100 may be performed, for example, by a MDCACE frontend 104 or MDCACE backend 110 discussed in connection with FIG. 1 or a computing device 900 discussed in connection with FIG. 9. In some embodiments, process 3100 may be used to create a user-defined or system-generated annotation layer.

In an embodiment, process 3100 includes creating 3102 a layer associated with a music score, for example, by a user such as illustrated in FIG. 16. In another embodiment, an annotation layer 3102 may be created by a computing device without human intervention. Such a system-generated layer may include automatically generated staging directions (such as discussed in connection with FIG. 26), orchestral cues, vocal line translations, or the like.

As part of creating the layer or after the layer has been created, one or more access control rules or access lists may be associated 3104 with the layer. For example, the layer may be associated with one or more access lists (e.g., a READ list and a WRITE list), each including one or more users or groups of users. In some cases, such access control rules or lists may be provided based on user configuration such as via the UI illustrated in FIG. 11. In other cases, the access control rules or lists may be provided by default (e.g., a layer may be publicly accessible by default, or private by default).

In some embodiments, one or more annotations may be added 3106 to the layer such as using a UI illustrated in FIG. 16. In some embodiments, an annotation may include a musical notation or expression, text, staging directions, free-drawn graphics and any other type of annotation. The annotations included in a given layer may be user-provided, system-generated, or a combination of both.

In an embodiment, the annotation layer may be stored 3108 along with any other layers associated with the music score in a local or remote data store such as server data store 112 discussed in connection with FIG. 1. The stored annotation layer may be shared by and/or displayed on multiple user devices.

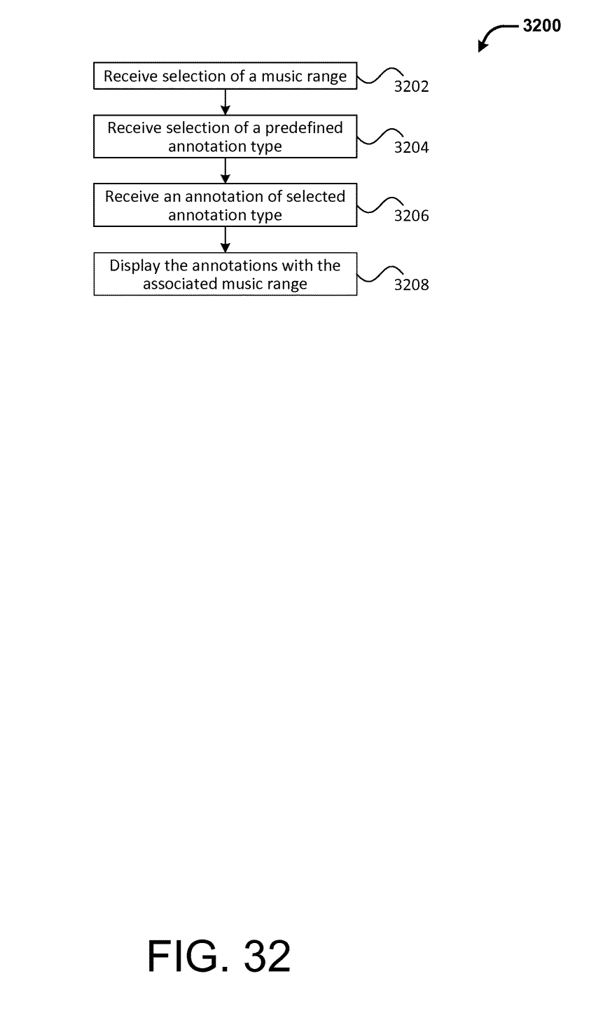

FIG. 32 illustrates an example process 3200 for providing annotations or score modifications, in accordance with at least one embodiment. Aspects of the process 3200 may be performed, for example, by a MDCACE frontend 104 discussed in connection with FIG. 1 or a computing device 900 discussed in connection with FIG. 9. In an embodiment, process 3200 may be used by a MDCACE frontend to receive an annotation or modification of a music score from a user.

In an embodiment, the process 3200 includes receiving 3202 a selection of a music range. In some embodiments, such a selection is received from a user via a UI such as illustrated in FIG. 20. In some embodiments, the selection of a music range may be made directly on the music score being displayed. In other embodiments, the selection may be made indirectly, such as via command line options. The selection may be provided via an input device such as a mouse, keyboard, finger, gestures or the like. The selected music range may encompass one or more temporally consecutive elements of the music score such as measures, staves, or the like. In addition, the selected music range may include one or more parts or systems (e.g., for violin and cello). In some embodiments, one or more (consecutive or non-consecutive) music ranges may be selected.

In an embodiment, the process 3200 includes receiving 3204 a selection of a predefined annotation or modification type (for simplicity, these are referred to in the figure as “annotation type”). Options of available types may be provided to a user via a UI such as illustrated in FIGS. 16-19 and FIG. 22. The user may select a desired type from the provided options. More or less options may be provided than illustrated in the above figures. For example, in some embodiments, users may be allowed to attach, as annotations or score additions, photographs, voice recordings, video clips, hyperlinks and/or other types of data. In some embodiments, the available types presented to a user may vary dynamically based on characteristics of the music range selected by the user, user privilege or access rights, user preferences or history (and, in some embodiments, related analyses thereof based upon algorithmic analyses and/or machine learning), and the like.

In an embodiment, the process 3200 includes receiving 3206 an annotation or modification of the selected type (for simplicity, these are referred to in the figure as “annotation type”). In some embodiments, such as illustrated in FIGS. 17-19, predefined annotation or modification objects with predefined types may be provided so that the user can simply select to add a specific object. In some embodiments, the collection of predefined objects available to users may depend on the annotation type selected by the user. In some other embodiments, such as for text annotations or additions, users may be required to provide further input for the annotation or addition. In yet some other embodiments, such as in the case for the automatically generated staging directions (discussed in connection with FIGS. 24-26), the annotation or addition may be provided as a result of user input (e.g., via the UI of FIG. 24) and system processing (e.g., detecting stage position changes and/or generating directions based on the detected changes). In some embodiments, the step 3204 may be omitted and users may create an annotation or addition or modification directly without first selecting a data type.

In some embodiments, the created annotation or modification is applied to the selected music range. In some embodiments, an annotation or modification may be applied to multiple (consecutive or non-consecutive) music ranges. In some embodiments, steps 3202, 3204, 3206 of process 3200 may be reordered and/or combined. For example, users may create an annotation or modification before selecting one or more music ranges. As another example, users may select an annotation or modification type as part of the creation thereof.

In an embodiment, the process 3200 includes displaying 3208 the annotations or modifications (for simplicity, these are referred to in the figure as “annotations”) with the associated music range or ranges, such as discussed in connection with FIG. 21. In some embodiments, annotations or modifications created by one user may become available (e.g., as part of an annotation layer) to other users such as in manners discussed in connection with FIG. 8. In some embodiments, the created annotation or modification is stored in a local or remote data store such as the server data store 112 discussed in connection with FIG. 1, client data store 218 connected to a master user device 214 as shown in FIG. 2, or a data store associated with the user device used to create the annotation.

According to an aspect of the present invention, music score displayed on a user device may be automatically configured and adjusted based on the display context associated with the music score. In various embodiments, display context for a music score may include zoom level, dimensions and orientation of the display device on which the music score is displayed, dimensions of a display area (e.g., pixel width and height of a browser window), the number of musical score parts that a user has selected for display, a decision to show a musical system only if all parts and staves within that system can be shown within the available display area, and the like. Based on different display contexts, different numbers of music score elements may be laid out and displayed.

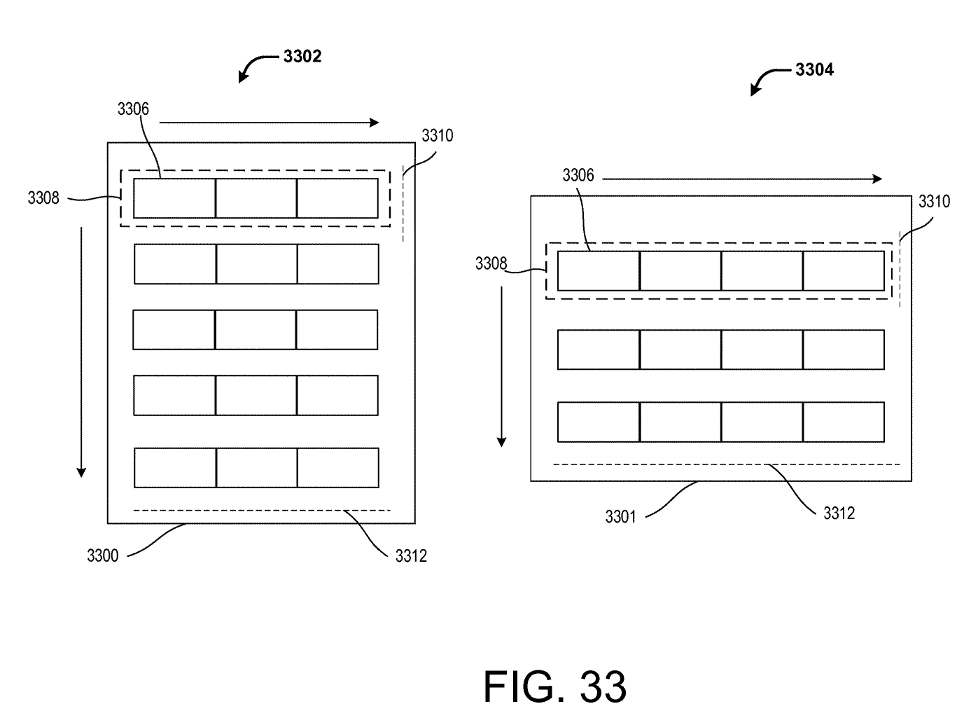

FIG. 33 illustrates some example layouts 3302 and 3304 of a music score, in accordance with at least one embodiment. The music score may comprise one or more horizontal elements 3306 such as measures as well as one or more vertical elements such as parts or systems 3308. In an embodiment, the characteristics of the display context associated with a music score may restrict or limit the number of horizontal elements and/or vertical elements that may be displayed at once.

For example, in the layout 3302, the display area 3300 is capable of accommodating three horizontal elements 3306 (e.g., measures) before a system break. As used herein, a system break refers to a logical or physical layout break between systems, similar to a line break in a document. Likewise, in the layout 3302, the display area 3300 is capable of accommodating five vertical elements 3308 before a page break. As used herein, a page break refers to a logical or physical layout break between two logical pages or screens. System and page breaks are typically not visible to users.

On the other hand, a different layout 3304 is used to accommodate a display area 3301 with different dimensions. In particular, the display area 3301 is wider horizontally and shorter vertically than the display area 3300. Thus, the display area 3301 fits more horizontal elements 3306 of the music score before the system break (e.g., four compared to three for the layout 3302), but fewer vertical element 3308 before the page break (e.g., three compared to five for the layout 3302). While in this example display area dimension is used as a factor for determining the music score layout, other factors such as zoom level, device dimensions and orientations, number of parts selected by user for display, and the like may also affect the layout.

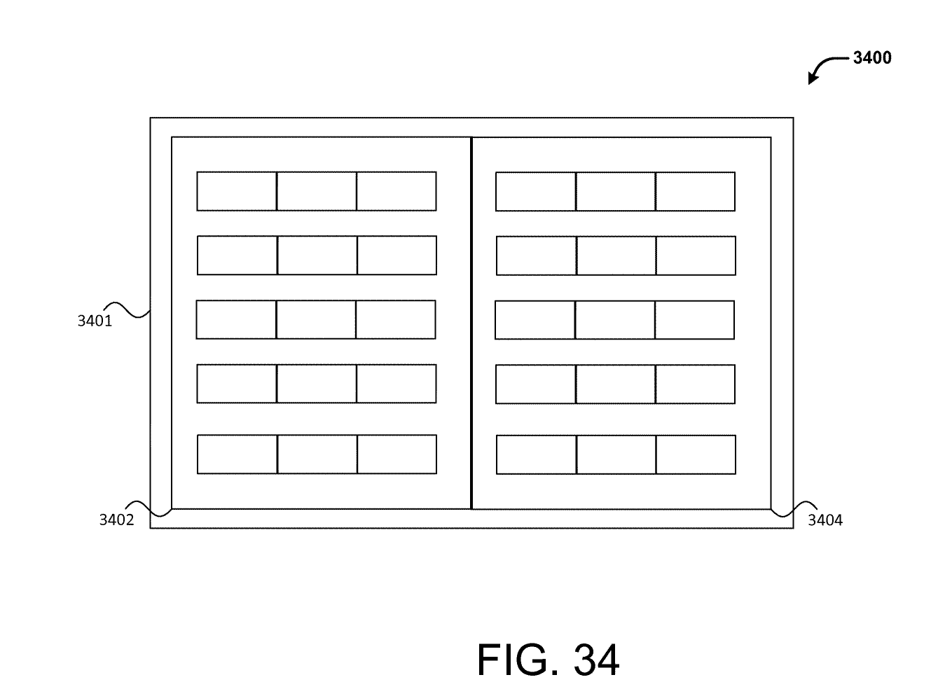

FIG. 34 illustrates an example layout 3400 of a music score, in accordance with at least one embodiment. In this example, the music score is laid out in a display area 3401 as two panels representing two consecutive pages of the music score. The panels may be displayed side-by-side similar to a traditional musical score. However, unlike traditional musical scores, content displayed in a given panel (e.g., total number of measures and/or parts) may increase or decrease depending on the display context such as illustrated in FIG. 33. In an embodiment, such changes may occur on a measure-by-measure and/or part-by-part basis. In various embodiments, users may navigate to backward and forward between the display of pages by selecting a navigation control, swiping the screen of the device with a finger, gesturing, or any other suitable methods.

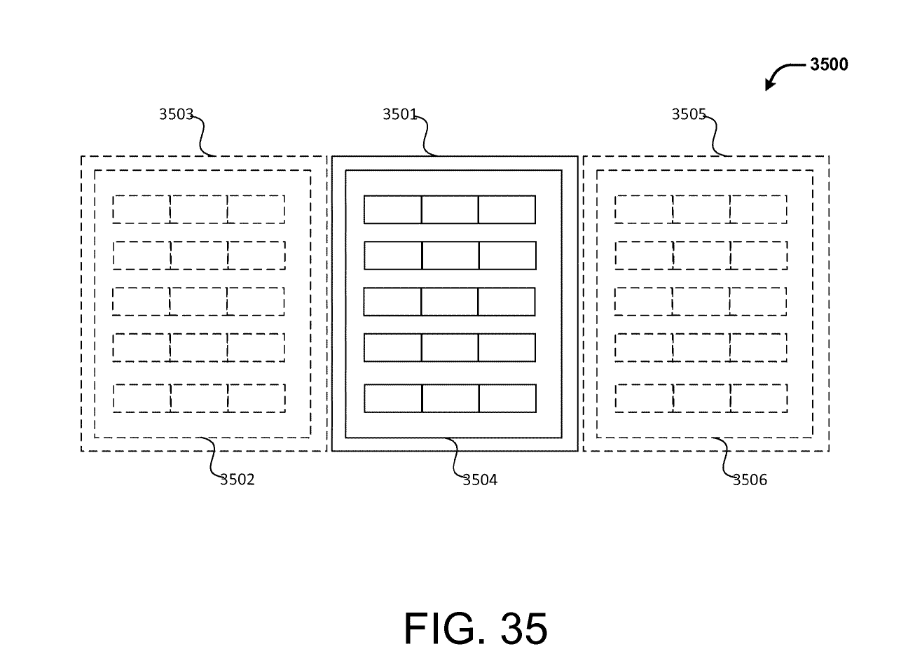

FIG. 35 illustrates an example embodiment 3500 of music score display, in accordance with at least one embodiment. In this example, the display area or display viewing port 3501 is configured to display one page 3504 at a time. Content displayed at the display viewing port is visible to the user. There may also be two or more hidden viewing ports on either side of the displayed viewing port, which includes content hidden from the current viewer. The hidden viewing ports may include content before and/or after the displayed content. For example, in the illustrated example, the viewing port 3503 contains a page 3502 that represents a page immediately before the currently displayed page 3504. Likewise, the viewing port 3505 contains a page 3506 that represents a page immediately after the currently displayed page 3504. Content in the hidden viewing ports may become visible in the display viewing port as user navigates backward or forward from the current page. This paradigm may be useful for buffering purposes.

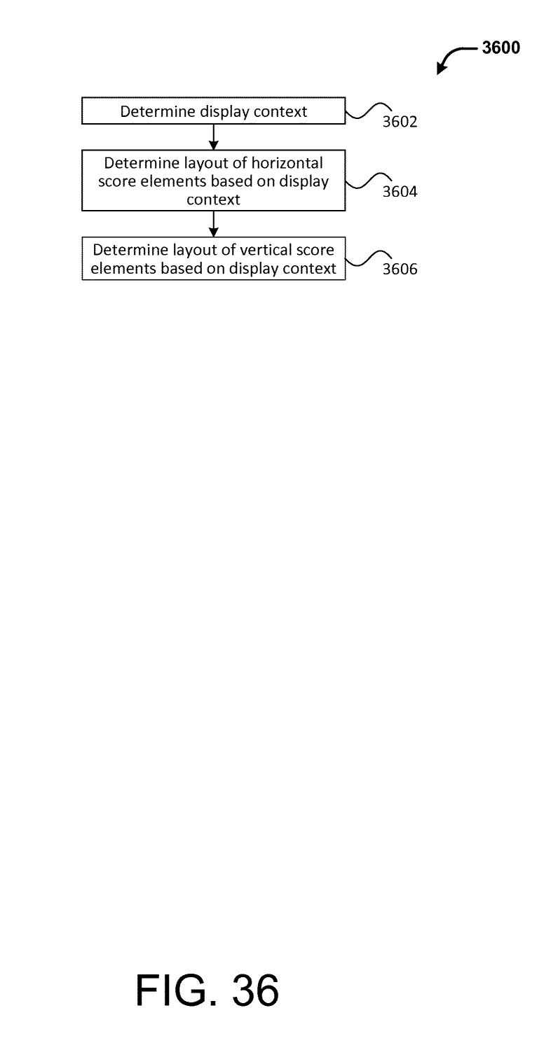

FIG. 36 illustrates an example process 3600 for displaying a music score, in accordance with at least one embodiment. The process 3600 may be implemented by a MDCACE frontend such as discussed in connection with FIG. 1. For example, process 3600 may be implemented as part of a rendering engine for rendering MusicXML or other suitable format of music scores.

In an embodiment, process 3600 includes determining 3602 the display context associated with the music score. In various embodiments, display context for a music score may include zoom level, dimensions and orientation of the display device on which the music score is displayed, dimensions of a display area (e.g., pixel width and height of a browser window), the number of musical score parts that a user has selected for display, and the like. Such display context may be automatically detected or provided by a user. Based on this information, the exact number of horizontal elements (e.g., measures) to be shown on the screen is determined (as discussed below) and only those horizontal elements are displaced. Should any factor in the display context changes (e.g. the user adds another part for display or changes the zoom level), the layout may be recalculated and re-rendered, if appropriate.

In an embodiment, process 3600 includes determining 3604 a layout of horizontal score elements based at least in part on display context. While the following discussion is provided in terms of measures, the same applies to other horizontal elements of musical scores. In an embodiment, the locations of system breaks are determined. To start with, the first visible part may be examined. The cumulative width of the first two measures in that part may be determined. If this sum is less than the width of the display area, the width of the next measure will then be added. This continues until accumulative sum is greater than the width of the display area, for example, at measure N. Alternatively, the process may continue until the sum is equal to or less than the width of the display area, which would occur at measure N−1. Accordingly, it is determined that the first system will consist of measures 1 through N−1, after which there will be a system break. Should not even one system fit the browser window's dimensions, the page may be scaled to accommodate space for at least one system.

Then, in order to draw the first system, the first measures within all visible parts are examined. For each part, the width of its first measure is determined based on the music shown in the measure. The maximum of such first measures of individual parts is used to ensure that all measures line up in all parts. This same process is applied for the remaining measures of that system. This ensures that measures line up in all parts.

In an embodiment, process 3600 includes determining 3606 the layout of vertical score elements based at least in part on the display context. While the following discussion is provided in terms of systems, the same applies to other vertical elements of musical scores. In order to determine where page breaks should be placed, the first system may be drawn as described above. If the height of the system measure is less than the height of the display area, the height of the system measure plus a buffer space between the systems will then be added. This continues until the sum is greater than the height of the display area, which will occur at system S. Alternatively, this can continue until the sum is equal to or less than the height, which would occur at system S−1. Accordingly, it is determined that the first page will consist of systems 1 through S−1, after which there will be a page break.

In an embodiment, this process 3600 is repeated on two other viewing ports on either side of the displayed viewing port, hidden from view (such as illustrated in FIG. 35). However, for the viewing port on the right, which represents the next page, the process begins from the next needed measure. The left viewing port, which represents the previous page, begins this process from the measure before the first of the current page, and works backwards. Should the previous page have already been loaded (e.g. the user flipped pages and has not changed his device's orientation or his viewing preferences), the previous page will be loaded as a carbon copy of what was previously the current page. This makes the algorithm more efficient. For example, should the browser be 768 by 1024 pixels, the displayed viewing port will be of that same size and centered on the web page. To the left and right of this viewing port will be two others of the same size; however, they will not be visible to the user. These viewing ports represent the previous and next pages, and are rendered under the same size constrictions (orientation, browser window size, etc.). This permits instantaneous or near-instantaneous page flipping.

According to another aspect of the present invention, various indications may be generated and/or highlighted (e.g., in noticeable colors) in a music score to provide visual cues to readers of the music score. For example, cues for singers may be placed in the score near the singer's entrance (e.g., two measures prior). As another example, orchestral cues for conductors may be generated, for example, according to process 3700 discussed below.

FIG. 37 illustrates an example process 3700 for providing orchestral cues in a music score, in accordance with at least one embodiment. In particular, musical score may be evaluated measure by measure and layer by layer to determine and provide orchestral cues. The orchestral cues may be provided as annotations to the music score. In some embodiments, the process 3600 may be implemented by a MDCACE backend or frontend such as discussed in connection with FIG. 1.

In an embodiment, process 3700 includes obtaining 3702 a number X that is an integer greater or equal to 1. In various embodiments, the number X may be provided by a user or provided by default. Starting 3704 with measure 1 of layer 1, the beat positions and notes of each given measure is evaluated 3706 in turn.

If it is determined 3708 that at least one note exists in the given measure, the process 3700 includes determining 3710 whether at least one note exist in the previous X measures. Otherwise, the process 3700 includes determining 3714 whether there are any more unevaluated measures in the layer being evaluated.

If it is determined 3710 that at least one note exist in the previous X measures, the process 3700 includes determining 3714 whether there are any more unevaluated measures in the layer being evaluated. Otherwise, the process 3700 includes automatically marking 3712 as a cue the beginning of the first beat of the measure being evaluated when a note occurs.

The process includes determining 3714 whether there are any more unevaluated measures in the layer being evaluated. If it is determined 3714 that there is at least one unevaluated measure in the layer being evaluated, then the process 3700 includes advancing 3716 to the next measure in the layer being evaluated and repeating the process from step 3706 to evaluate beat positions and notes in the next measure. Otherwise, the process 3700 includes determining 3718 whether there is at least one more unevaluated layer in the piece of music being evaluated.

If it is determined 3718 that there is at least one more unevaluated layer in the piece of music being evaluated, then the process 3700 includes advancing to the first measure of the next layer and repeating the process 3700 starting from step 3706 to evaluate beat positions and notes in the next measure. Otherwise, the process 3700 ends 3722. In some embodiments, alerts or messages may be provided to a user to indicate the ending of the process.

In various embodiments, additional embodiments, functionalities or features may be provided for the present invention, some of which are discussed below.

Other Elements that can be Displayed and Hidden

Beyond layers, other elements of the score can be displayed or hidden at will. Such elements may include any of the following.

1. Cuts. Musical Directors will often cut certain sections of music. This information is transmitted in real-time with the MDCACE system. Then cut music can be simply hidden, rather than appearing but crossed out. This can be treated as an annotation: the user selects the range of music to be cut (in any number of parts, since the same passage of music will be cut for all parts), then in the annotations panel as discussed above the user chooses “Cut.” For instance, if the user chooses to cut measures 11-20, he would select measures 11-20, then select “Cut,” and then measure 10 will simply be followed by what was previously measure 21, and this will then be relabeled measure 11; a symbol indicating a cut will appear above the bar line (or in some other logical place) between measures 10 and 11 that indicates that a section of the score was cut, and selecting this symbol can toggle re-showing the hidden measures. Alternatively, creating a cut could be accomplished by choosing, for instance, “Cut” from within some other menu of tools, and the user would then select the range of measures to be cut; this would be useful for long passages of music to be cut, when selecting the passage of music per the alternative paradigm above would be arduous.

2. Alternative versions of pieces of music, such as arias. Here, a small comment/symbol can indicate that there is an alternative passage of music that can be expanded.

3. Transpositions. Singers will sometimes transpose music into different keys. This can be done not only for the singer but also simultaneously for the entire orchestra as well. In addition, simply showing transposed instruments (e.g. clarinets) vs. concert pitch can also be done instantly in MDCACE.

4. Re-orchestration (changing of instruments).

5. Additional layers for different translations, International Phonetic Alphabet, etc. For example, the user can choose from different versions of translation such as “translation 1,” “translation 2” and such.

### Dissonance Detection

According to another aspect of the present invention, dissonances between two musical parts in temporally concurrent passages may be automatically detected. Any detected dissonance may be indicated by distinct colors (e.g., red) or by tags to the notes that are dissonant. The following process for dissonance detection may be implemented by a MDCACE backend, in accordance with an embodiment:

1. Examine notes between two musical parts in temporally concurrent passages.

2. Determine the musical intervals between the notes in the two parts (i.e., the number of half-steps between two parts), represented as |X1−X2|, respectively.

3. Determine whether dissonance occurs based on the value of the musical interval determined above. In particular, in an embodiment, the number of intervals mod 12 (i.e., |(X1−X2)|%12) is determined. If the result is 1, 2, 6, 10, or 11, then it is determined there is dissonance, for example, because the interval is a minor second, major second, tritone, minor seventh, major seventh, or some interval equivalent to these but expanded by any whole number of octaves. Otherwise, it may be determined that there is no dissonance. As an example, if the first musical part at a given time indicates F#4, and the second indicates C6, there are 18 half-steps between them (|F#4−C6|=18), and 18%12=6, thus this is a dissonance.

Indication of such dissonance may be provided as annotations in the music score or as messages or alerts to the user.

### Playback & Recording

In an embodiment, music scores stored in the MDCACE system may be played using a database of standard MIDI files or some other collection of appropriate sound files. Users may choose to play selected elements, such as piano reduction, piano reduction with vocal line, orchestral, orchestral with vocal line, and the like. This subset of elements playing can match those elements being displayed (automatically), or they can be different. Individual layers can be muted or half-muted, or soloed, and volumes changed.

In an embodiment, voice recorder may be provided. Recordings generated from the MDCACE system can be exported and automatically synchronized to popular music software or as regular music files (e.g. in mp3 format).

### Master User

A master MDCACE user as described above can advance the score measure by measure, or page by page, or by some other unit (e.g., by dragging a finger along the score). As the music score is advanced by the master user, any of the following may happen, according to various embodiments:

1. Progression of supertitles. In an embodiment, supertitles can be generated and projected as any given vocal line is being sung. The supertitles may include translation of the vocal line.

2. Progression of orchestral players' and conductors' scores, for example, in a manner discussed in connection with FIG. 27.

3. Lighting and sound cues occur, for example, as annotations.

4. Singers are automatically paged to on stage. In an embodiment, contact information (e.g., page number, phone number, email address, messenger ID) of one or more singers or actors may be associated with a music range as annotations. The system may automatically contact these singers or actors accordingly when the associated music range is reached with or without predefined or user-provided information.

### Real-Time Collaboration Using Operational Transformation

Some embodiments of the invention use operational transformation (“OT”) paradigms in order to allow multiple users to simultaneously compose and/or edit and/or otherwise modify musical scores at the same time using separate clients. In some such embodiments, a data model is imposed that provides additional semantics to the information communicated and preserved these transformations.

In some embodiments, operational transformations are performed on the MDCACE server. In other embodiments, operational transformations are performed on the front end, i.e., on a client device.

When a user modifies a document describing a musical score in a client application that supports interaction with that musical score—for instance, music notation software—a changeset is produced. A changeset represents a single edit to a document, either an Insert or Delete operation. Each changeset has a musical address specifying the location of the data into insert or delete, as well as data specific to the object being edited. The changeset (“Op”) is sent to the OT server, which transforms the changeset before broadcasting the transformed changeset (“Op_{—}1”) to the other clients.

Changesets describe the operation being performed, namely an insertion or deletion; the location of this operation; and the data model being involved.

In some embodiments, changesets are represented as objects, such as the following: {operation: {“Insert” or “Delete”}, location: {LOCATION OBJECT}, data: {DATA MODEL}, uid: Hash/UID}. In some embodiments, these might be JSON objects.

“Insert” or “Delete” refers to inserting or deleting some data model. For instance, a user might add a fermata or delete a staccato marking.

The location object specifies a musically semantic location of the edit operation, as described below. In some embodiments, the location object consists of the following five parameters: part, staff, measure, voice, and ticks. Locations are encoded into separate objects in order to convey information pertaining to each. Following are descriptions of each of these parameters:

1. A document consists of one or more parts that generally represent a single instrument and/or performer. For instance, a string quartet has four parts, one per instrument.

2. Each part consists of 1, 2, or sometimes 3 staves. For instance, a piano grand staff has two staves in that one part; the top staff generally represents notes to be played by the right hand and uses a treble clef, whereas the bottom staff generally represents the notes to be played by the left hand and uses a bass clef.

3. A document consists of one or more measures, which represent time organization within the document. In some embodiments, the score is considered consistent with respect to time, meaning that all parts occupy the same time. This remains true even if a part is visibly hidden for a period of time. Documents in which each part may occupy a different amount of time are considered inconsistent. In other embodiments, the changeset conveys data in a manner that supports inconsistent documents as described above.

4. Each staff has at least 1 voice.

5. Each measure has a number of rhythmic ticks, which represent time subdivisions within that measure. In some embodiments, the score is considered consistent with respect to barlines, meaning that all barlines across all parts occur at the same time. This applies in cases wherein one part may be in 3/4 meter while another part may be in 6/8 meter—or in any other case in which the meter of one part in question represents a fraction mathematically equivalent to the meter of another part—as well as in the case of polymeter with synchronized barlines. In other embodiments, the changeset conveys data in a manner that supports polymeter with unsynchronized barlines.

Each delta has a start location (“startLocation”) and, if the delta applies to a range (i.e., if the range is greater than one note), a stop location (“stopLocation”). For instance, a fortissimo mark would apply only to one note, so the startLocation would equal the stopLocation, making the stopLocation duplicative. By contrast, a slur applying to five notes would have a stopLocation that is later in time than the startLocation. In an alternative embodiment, even if the startLocation equals the stopLocation, both are included.

This schema specifies a location within the score corresponding to a specific MIDI or similar position. In some embodiments, this is further refined to include alternate or finer-resolution timecodes, as well as deltaX/deltaY graphical offsets from an object's default position in a client display.

In some embodiments, address indices may start at some number (such as zero) and then increase, in which case some specific address (such as −1) would serve to indicate an ALL flag; in this case, that specific address (such as −1) might indicate that an operation applies to all voices, or to all parts, etc.

In some embodiments, other similar parameters to those described above might be included, potentially along with some or all of the above parameters.

The data model (also referred to herein as “type”) field as described above encodes what the operation is inserting or deleting. Examples of types supported by some embodiments include: chord symbols; roman numeral symbols; functional bass symbols; articulations, such as staccato and tenuto; dynamics, such as p, mf, and f; expressions, such as legato; fermatas; hairpin crescendos and decrescendos; highlighted regions of the score; ornaments, such as trills and turns; slurs; technique symbols and text, such as arco and pizz; piano fingerings; tempo indications; other words; lyrics; and MIDI data.

In some embodiments, a unique identifier (“UID”) or object hash is specified with each edit operation to prevent ambiguity when multiple similar objects may occur at or near the specified address.

Following are some example operations including the operation and location fields:

1. Insert[Part: 0, Staff: 0, Measure: 15, Voice: 0, Ticks: 192, Offset: (0, −10), Content: {Dynamics: “p”}]

2. Delete[Part: 0, Staff 0, Measure: 15, Voice: 0, Ticks: 0, Content: {Chord: [C, E]}]

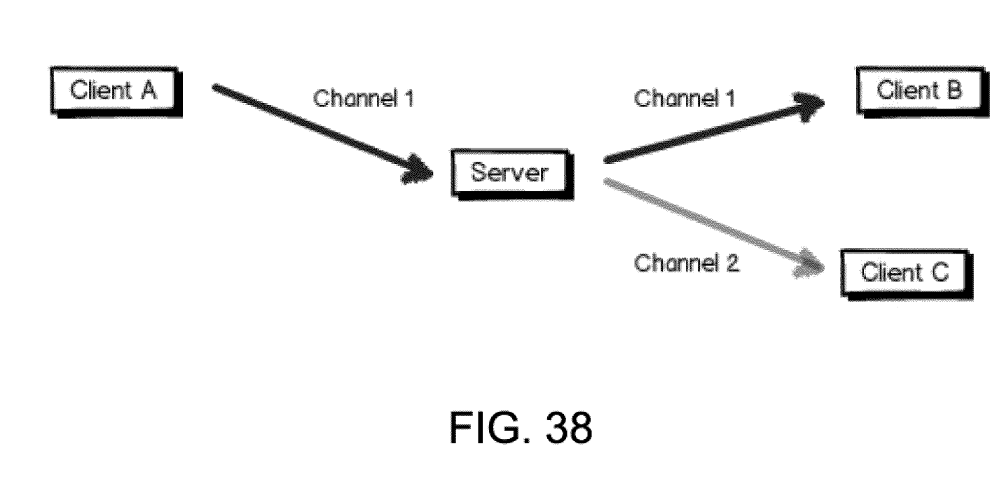

In some embodiments, when a client connects to the server, it connects to a specific channel that corresponds to the document being edited by that client. In some embodiments, this channel is identified by the document's internal ID within the database, though it could be any unique document identifier. When a client makes a change to the document, the client sends a message to the server. The server then rebroadcasts this change to all other clients in the same channel. This process is illustrated in FIG. 38: Client A sends a delta to the server to channel 1; the server then broadcasts this change to Client B, which is also on channel 1; Client C, which is on channel 2, does not receive this delta.

In some embodiments, changesets may also include some or all of the following information: the identification of the score to which the delta applies; the identification of the user who created the delta; the display name of the user who created this delta; the datetime string of the time that this change was generated; and additional type-specific information.

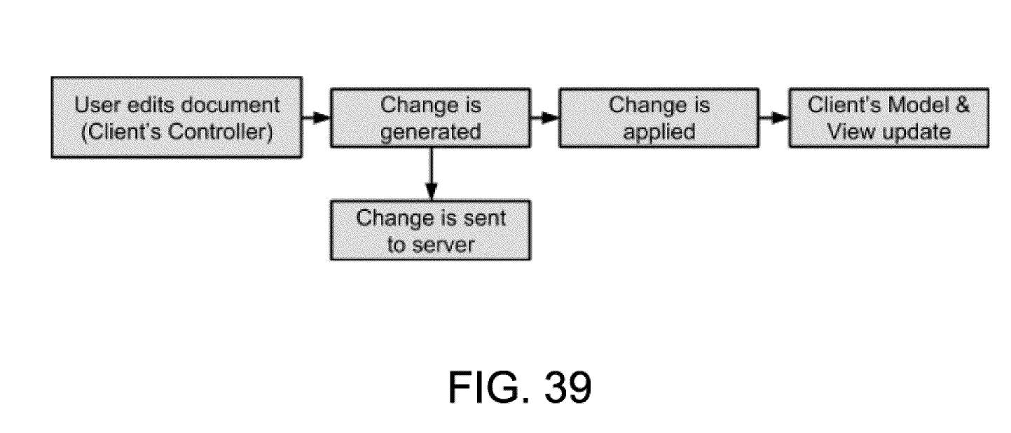

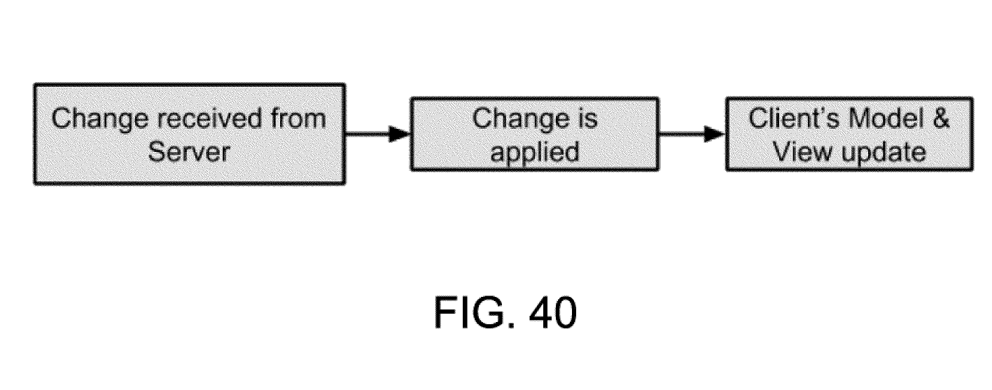

In some embodiments, using a model-view-controller paradigm, changesets are generated whenever the client's internal document model changes. A delta is generated based on the change and is then sent to the server, after which the client's view is updated appropriately. This is represented in FIG. 39. When a client receives an update from the server, the client updates its model and view to reflect the latest changes. This process is illustrated in FIG. 40. In such embodiments, the client responds to these changes in the same way that the client would process a user's local changes. A response from the server will sometimes cause a change to the model, which will invalidate some part of the view and cause some part of the view to re-render.

In some embodiments, users may be divided into the following or similar roles:

1. Read/Public Write—Such users can modify the document such that all users can view modifications.

2. Read/Private Write—Such users can see their own document modifications. Modifications are not publicly visible.

3. Read—Such users can receive document changes but cannot modify the document.

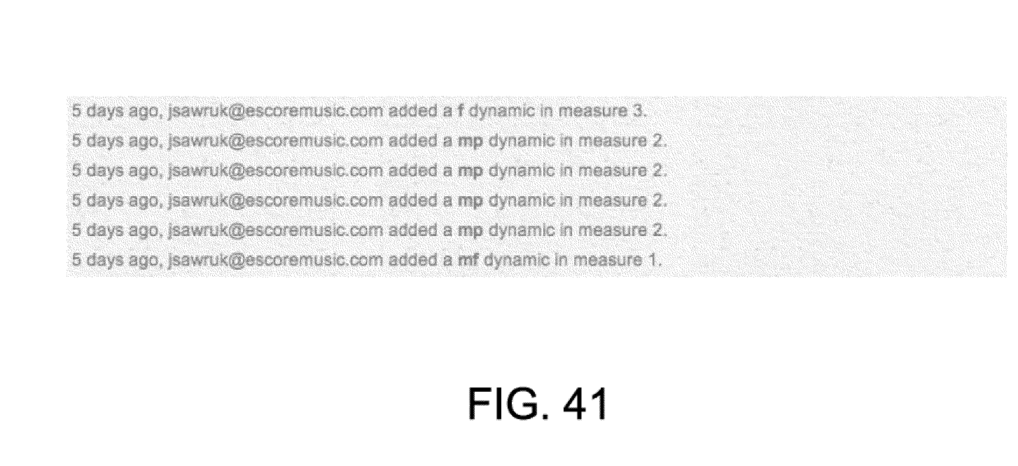

In some embodiments, the MDCACE front end displays historical changes made to musical scores, where these changes are represented by the changesets. This data might be represented in a table or other similar representation that communicates changesets in one unified view. An example UI for this is presented in FIG. 41. Such a system might communicate the amount of time that has elapsed since certain changes, in terms of seconds, minutes, hours, days, weeks, months, and/or years. Other embodiments display the actual point in time when such changes occurred, by indicating a specific second, minute, hour, day (either date or day of the week), month, and/or year, potentially along with a time zone. Other embodiments include similar information.

In some embodiments, sets of these changesets, wherein these sets contain at least one such changeset, are applied to the current document in order to derive the previous state of the current document. In other embodiments, changesets are applied to an original document in order to derive the current state. Both of these embodiments allow derivation of the state of a document after any subset of changes. This in turn allows users to view the scores after some or all changes have occurred. As an example, if a document representing a score starting with state X at time 0 has changesets A, B, C, D, and E that occurred at time points 1, 2, 3, 4, and 5, respectively, the user could view the state of the document at any of these 5 time points. Following are examples of four different methods in which MDCACE can calculate the state of the document at various time points, some or all of which methods are implemented in various embodiments:

1. By applying changeset A to state X, the state of the document at time 1 is derived; by applying changeset B to the then-derived state of the document at time 1, the state of the document at point 2 is derived; etc.

2. By applying changeset A to state X, the state of the document at time 1 is derived; by applying changeset A and then changeset B to the state at state X, the state of the document at point 2 is derived directly, without first needing to derive the states of the document at point 1; etc.

3. By applying the opposite of changeset E to state 5, the state of the document at time 4 is derived; by applying the opposite of changeset D to the then-derived state of the document at time 4, the state of the document at point 3 is derived; etc. To provide an example of the opposite of a changeset: if the changeset represents adding a fermata to a certain note, the opposite of that changeset would represent eliminating that fermata. In particular, the opposite of the removal of some object is the addition of that object, and the opposite of the addition of some object is the removal of that object. In some embodiments, additional similar relationships are used.

4. By applying the opposite of changeset E to state 5, the state of the document at time 4 is derived; by the opposite of changeset E and then the opposite of changeset D to the state at state 5, the state of the document at point 3 is derived directly, without first needing to derive the states of the document at point 4; etc.

In some embodiments, a UI allows the user to click on a row as depicted in FIG. 41 and to choose a specific time point at which to view the state of the document. In some embodiments, advantageously, the user can revert the document to a previous time point.

In some embodiments, these changesets are used to allow the user to undo or redo modifications or annotations to a score by using the same processes described above, working with two consecutive timepoints and the changeset representing the difference between them.

In some embodiments, operational transformations might apply to specific annotation layers, as described above.

Although preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A computer-implemented method for providing, creating, and editing musical score information associated with a document representing a musical score, said method under the control of one or more computer systems configured with executable instructions and comprising:
(a) storing a plurality of layers of the musical score information, with at least some of the plurality of layers of musical score information received from one or more users; and
(b) providing, in response to request by a user to display the musical score information, a subset of the plurality of layers of the musical score information based at least in part on an identity of the user.

2. The method of claim 1, wherein the plurality of layers of the musical score information includes at least a base layer comprising a part of the musical score and an annotation layer comprising one or more annotations applicable to the part layer.

3. The method of claim 2, wherein the annotation layer is system-generated.

4. The method of claim 1, wherein the plurality of layers of the musical score information includes at least a layer comprising one or more vocal lines, piano reductions, musical cuts, musical symbols, staging directions, dramatic commentaries, notes, lighting and sound cues, orchestral cues, headings or titles, measure numbers, transpositions, re-orchestrations, or translations.

5. The method of claim 1, wherein at least one layer of the subset of the plurality of layers is associated with one or more access control rules, and wherein providing the subset of the plurality of layers of the musical score information is based at least in part on the one or more access control rules.

6. The method of claim 5, wherein the one or more access control rules pertain to read and write permissions regarding the at least one layer.

7. The method of claim 1, further comprising causing rendering of some of the subset of the plurality of layers of the musical score information on a device associated with the user based at least in part on a user preference.

8. One or more non-transitory computer-readable storage media having stored thereon executable instructions that, when executed by one or more processors of a computer system, cause the computer system to at least:
(a) provide a user interface configured to display musical score information associated with a music score as a plurality of layers;
(b) display, via the user interface, a subset of the plurality of layers of musical score information based at least in part on a user preference;
(c) receive, via the user interface, a modification to at least one of the subset of the plurality of layers of musical score information; and
(d) display, via the user interface, the modification to at least one of the subset of the plurality of layers of musical score information.

9. The one or more computer-readable storage media of claim 8, wherein the user preference indicates whether to show or hide a given layer in the user interface.

10. The one or more computer-readable storage media of claim 8, wherein the user preference includes a display color for a given layer or an annotation.

11. The one or more computer-readable storage media of claim 8, wherein the modification includes at least one of adding, removing, or editing an annotation.

12. The one or more computer-readable storage media of claim 11, wherein the annotation includes a comment, a musical notation, a free-drawn graphics object, or a staging direction.

13. The one or more computer-readable storage media of claim 11, wherein adding the annotation comprises:
(a) receiving, via the user interface, a user-selected music range of music score; and
(b) associating the annotation with the user-selected music range.

14. The one or more computer-readable storage media of claim 8, wherein the executable instructions further cause the computer system to enable a user to create, via the user interface, a new layer associated with the music score.

15. The one or more computer-readable storage media of claim 8, wherein the user interface is configured to receive user input that is provided via a keyboard, mouse, stylus, finger or gesture.

16. A computer system for facilitating musical collaboration among a plurality of users each operating a computing device, comprising:
one or more processors; and
memory, including instructions executable by the one or more processors to cause the computer system to at least:
(a) receive, from a first user of the plurality of users, an annotation layer comprising one or more annotations associated with a music score and one or more access control rules associated with the annotation layer; and
(b) make the annotation layer available to a second user of the plurality of users based at least in part on the one or more access control rules.

17. The computer system of claim 16, wherein at least some of the one or more access control rules are configured by the first user.

18. The computer system of claim 16, wherein the instructions further cause the computer system to receive a modification to the annotation layer from the second user and making the modification available to the first user.

19. The computer system of claim 16, wherein the instructions further cause the computer system to enable two or more users of the plurality of users to collaborate, in real time, in providing a plurality of annotations to the music score.

20. The computer system of claim 16, wherein the instructions further cause the computer system to detect a dissonance in the music score.

21. The computer system of claim 16, wherein the instructions further cause the computer system to generate one or more orchestral cues for the music score.

22. The computer system of claim 16, wherein the instructions further cause the computer system to enable at least one master user of the plurality of users, operating at least one master device, to control at least partially how the music score is displayed on one or more non-master devices operated respectively by one or more non-master users of the plurality of users.

23. The computer system of claim 22, wherein controlling at least partially how the music score is displayed on the one or more non-master devices operated respectively by the one or more non-master users of the plurality of users includes causing advancement of the music score displayed on the one or more non-master devices.

24. The computer system of claim 23, wherein the advancement of the music score provides a continuous display of the music score.

25. A computer-implemented method for displaying a written representation of music on a user device associated with a user, said method under the control of one or more computer systems configured with executable instructions and comprising:
determining a display context associated with the written representation of music; and
rendering a number of elements of the written representation of music on the user device, the number selected based at least in part on the display context.

26. The method of claim 25, wherein the written representation of music includes a musical score.

27. The method of claim 25, wherein the display context includes at least a zoom level, dimension of the display device, orientation of the display device, or dimension of a display area.

28. The method of claim 26, wherein display context includes at least a number of musical score parts selected for display by the user.

29. The method of claim 26, further comprising:
(a) detecting a change in the display context; and
(b) rendering a different number of musical score elements on the user device, the different number selected based at least in part on the changed display context.

30. The method of claim 1, wherein mediation by a server, a peer-to-peer network, or a local area network coordinates simultaneous creation and/or modification of such documents by multiple independent client devices at the same time.

31. The method of claim 30, wherein operational transformations accomplish this mediation.

32. The method of claim 31, wherein a data model used to represent the changesets of these transformations preserves musically semantic information about these transformations.

33. The method of claim 32, wherein such a data model and its associated changesets allows derivation of the state of a document representing a musical score as that document has existed at different points in time, based upon applying incremental changesets or their opposites to the state of the document at some point in time, wherein the opposite of a changeset indicating an addition of some data model is equal to the deletion of that data model, and the opposite of a changeset indication a deletion of some data model is equal to the addition of that data model.

34. The method of claim 33, wherein such derivations allow the user to quickly view different states of the document as it existed at different points in time, and, if desired, to adapt one of these different states as the current state, effectively reverting the document as it had been at that state.
